(19) United States
(12) Patent Application Publication
(10) Pub. No.: US 2025/0139643 A1
(43) Pub. Date: May 1, 2025

(54) METHODS AND SYSTEMS FOR FACILITATING MANAGING CLOUDS FOR A USER

(71) Applicants: Vijay Karia, Mt Kisco, NY (US); Alton Allen, East Bridgewater, MA (US)

(72) Inventors: Vijay Karia, Mt Kisco, NY (US); Alton Allen, East Bridgewater, MA (US)

(21) Appl. No.: 18/926,012

(22) Filed: Oct. 24, 2024

Related U.S. Application Data
(60) Provisional application No. 63/593,088, filed on Oct. 25, 2023.

(51) Int. Cl. G06Q 30/018; H04L 41/16

(52) U.S. Cl. CPC G06Q 30/018; H04L 41/16

(57) ABSTRACT

The present disclosure provides a method for facilitating managing clouds for a user. Further, the method includes receiving requests from user devices associated with users. Further, the method includes receiving information from the devices based on the requests. Further, the information is associated with clouds of the users. Further, the clouds are provided by cloud platforms. Further, the method includes analyzing the information. Further, the method includes determining cloud management actions for managing the clouds based on the analyzing of the information. Further, the method includes generating management information based on the determining of the cloud management actions. Further, the management information facilitates a performing of the cloud management actions. Further, the method includes transmitting the management information.

### REFERENCE TO RELATED APPLICATIONS

This application claims the benefit of U.S. Provisional Patent Application No. 63/593,088, titled “METHODS AND SYSTEMS FOR CLOUD OPTIMIZATION AND CLOUD MERGING, AND AUTOMATED INFRASTRUCTURE AS CODE, SCRIPTED DISASTER RECOVERY, AND DIGITAL RECYCLING”, filed Oct. 25, 2023, which is incorporated by reference herein in its entirety.

### FIELD OF DISCLOSURE

Generally, the present disclosure relates to the field of data processing. More specifically, the present disclosure relates to methods and systems for facilitating managing clouds.

### BACKGROUND

The field of data processing is technologically important to several industries, business organizations, and/or individuals. In particular, the use of data processing is prevalent for methods and systems for facilitating managing clouds.

Existing techniques for facilitating managing clouds are deficient with regard to several aspects. For instance, current technologies do not provide cost-effective solutions to optimally utilize cloud computing platforms or any solution for recycling unused digital assets. Furthermore, current technologies do not provide user-specific solutions for optimal data storage using cloud computing platforms. In general, clouds are oversized and developers do not want to be responsible for systems going down. There is an oversizing that happens to lead to overspending on the cloud infrastructure. Some of the oversizing also occurs due to duplication of cloud infrastructure for the purpose of disaster recovery. Many times these disaster recovery platforms never get utilized or they get utilized at low frequency. Furthermore, IAC (Infrastructure as code) scripts take several months for developers to build so many do not, therefore creating a problem for companies leaving the companies vulnerable in case of disaster recovery or slowing down development efforts. Lastly, many companies utilize multiple cloud providers due to acquisitions further leading to duplicated cloud environments or inefficiencies in the companies' clouds that lead to greater carbon emissions.

Further, in existing technologies, unused digital assets are put to waste. Moreover, there are less cost-effective solutions for optimizing the utilization of resources. As a result, different technologies are needed for the provisioning of cost-effective solutions and recycling the unused digital assets. In existing technologies, duplicated cloud environments exist due to the usage of multiple cloud providers. Moreover, the duplicated environments and increase in servers of the cloud environment cause greater carbon emissions. As a result, different technologies are needed to reduce carbon emissions. In existing technologies, the duplicated environments also cause an increase in the expenditure of companies. Moreover, the duplicated environments exist due to the increased development time of Infrastructure as a Code (IAC) scripts. As a result, different technologies are needed for automating the IAC scripts for cloning the cloud environment on identification of a compromised system. Moreover, the elimination of duplicated environments reduces the expenditure of the companies.

In existing technologies, the need for digital recycling of unused, redundant, and/or unrequired digital assets is neglected. Further, the redundant digital assets among others include duplicated data (such as photos, junk emails, etc.) on devices (such as personal devices). As a result, different technologies are needed for recycling unused, redundant, and/or unrequired digital assets into carbon credits.

Therefore, there is a need for improved methods and systems for facilitating managing clouds that may overcome one or more of the above-mentioned problems and/or limitations.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method for facilitating managing clouds for a user. Further, the method may include receiving, using a communication device, one or more requests from one or more user devices associated with the user. Further, the method may include receiving, using the communication device, one or more information from one or more devices based on the one or more requests. Further, the one or more information may be associated with one or more clouds of the user. Further, the one or more clouds may be provided to the user by one or more cloud platforms. Further, the method may include analyzing, using a processing device, the one or more information. Further, the method may include determining, using the processing device, one or more cloud management actions for managing the one or more clouds of the user based on the analyzing of the one or more information. Further, the method may include generating, using the processing device, one or more management information based on the determining of the one or more cloud management actions. Further, the one or more management information facilitates a performing of the one or more cloud management actions for the managing of the one or more clouds. Further, the method may include transmitting, using the communication device, the one or more management information.

The present disclosure provides a system for facilitating managing clouds for a user. Further, the system may include a communication device. Further, the communication device may be configured for receiving one or more requests from one or more user devices associated with the user. Further, the communication device may be configured for receiving one or more information from one or more devices based on the one or more requests. Further, the one or more information may be associated with one or more clouds of the user. Further, the one or more clouds may be provided to the user by one or more cloud platforms. Further, the communication device may be configured for transmitting one or more management information. Further, the system may include a processing device communicatively coupled with the communication device. Further, the processing device may be configured for analyzing the one or more information. Further, the processing device may be configured for determining one or more cloud management actions for managing the one or more clouds of the user based on the analyzing of the one or more information. Further, the processing device may be configured for generating the one or more management information based on the determining of the one or more cloud management actions. Further, the one or more management information facilitates a performing of the one or more cloud management actions for the managing of the one or more clouds.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating managing clouds for a user, in accordance with some embodiments.

FIG. 4 illustrates a flowchart of a method 400 for facilitating managing clouds for a user including analyzing, using the processing device 1204, the at least one first information and the spending corresponding to the usage using at least one machine learning model, in accordance with some embodiments.

FIG. 5 illustrates a flowchart of a method 500 for facilitating managing clouds for a user including generating, using the processing device 1204, at least one recommendation for optimizing a spending associated with the at least one cloud, in accordance with some embodiments.

FIG. 6 illustrates a flowchart of a method 600 for facilitating managing clouds for a user including determining, using the processing device 1204, at least one optimized cloud infrastructure information of an optimized cloud infrastructure associated with the at least one cloud, in accordance with some embodiments.

FIG. 7 illustrates a flowchart of a method 700 for facilitating managing clouds for a user including calculating, using the processing device 1204, a reduction in the carbon emission, in accordance with some embodiments.

FIG. 8 illustrates a flowchart of a method 800 for facilitating managing clouds for a user including generating, using the processing device 1204, at least one carbon credit information based on the converting of the reduction in the energy consumption into the carbon credit, in accordance with some embodiments.

FIG. 9 illustrates a flowchart of a method 900 for facilitating managing clouds for a user including analyzing, using the processing device 1204, the at least one query using the at least one machine learning model, in accordance with some embodiments.

FIG. 10 illustrates a flowchart of a method 1000 for facilitating managing clouds for a user including receiving, using the communication device 1202, at least one response of the at least one user associated with at least one of the at least one optimization tool and the at least one cloud resource from the at least one user device, in accordance with some embodiments.

FIG. 11 illustrates a flowchart of a method 1100 for facilitating managing clouds for a user including receiving, using the communication device 1202, at least one input of the user associated with the at least one questionnaire from the at least one user device, in accordance with some embodiments.

FIG. 12 illustrates a block diagram of a system 1200 for facilitating managing clouds for a user, in accordance with some embodiments.

FIG. 13 illustrates a block diagram of the system 1200 for facilitating managing the clouds for the user, in accordance with some embodiments.

FIG. 14 is a block diagram of a system 1400 for facilitating cloud optimization, in accordance with some embodiments.

FIG. 15 is a flowchart of a method 1500 for facilitating cloud optimization, in accordance with some embodiments.

FIG. 16 is a flowchart of a method 1600 for facilitating cloud optimization and merging, in accordance with some embodiments.

FIG. 17 is a flowchart of a method 1700 for facilitating cloud optimization and merging, in accordance with some embodiments.

FIG. 18 is a flowchart for a method 1800 for facilitating cloud optimization, in accordance with some embodiments.

FIG. 19 is a flowchart for a method 1900 for facilitating cloud optimization, in accordance with some embodiments.

FIG. 20 is a flowchart for a method 2000 for facilitating cloud optimization, in accordance with some embodiments.

FIG. 21 is a flowchart for a method 2100 for facilitating cloud optimization, in accordance with some embodiments.

FIG. 22 is a block diagram of a system 2200 for facilitating cloud optimization, in accordance with some embodiments.

FIG. 23 is a block diagram of a system 2300 for facilitating cloud optimization, in accordance with some embodiments.

FIG. 24 is a flowchart for a method 2400 for facilitating cloud optimization, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems for facilitating managing of clouds.

The present disclosure describes methods and systems for facilitating cloud optimization, automated infrastructure as code, scripted disaster recovery, cloud merging, cloud migration, datacenter migration, and digital recycling of optimized cloud resources into carbon credits, and unused, redundant, and/or unrequired digital assets (such as junk emails, junk pictures, junk data, etc.) present on devices (such as personal devices) and/or platforms (such as Customer relationship Management (CRM)). Further, the disclosed system may be associated with a software sass product that allows businesses to optimize the businesses cloud by being able to scan the latest documents of the AWS, Microsoft Azure, and Google Cloud Platform. Further, the system may run these documents into a vector database and pass the documents through an LLM model to automatically produce terraform for a company's cloud environment or reduce the company's spending on the company's cloud bill through automated comparison of the company's cloud and suggestions from the LLM model based on rates from AWS, Azure, and Google Cloud Platform in comparison to the company's usage. Data for billing and usage may be pulled from the AWS, Azure, and Google API after login from the company. The system may use document scanning and AI models (such as ML models, generative AI models, LLM models, generative pre-trained transformer (GPT) (such as ChatGPT), etc.) to migrate or merge multi-cloud environments by automatically producing the scripts needed to perform the migration of one cloud environment (AWS, Azure, and Google Cloud Platform) to another.

Further, the system may optimize cloud service reduce spending on cloud costs, and automate infrastructure as code, automate IAC scripts for new instant disaster recovery techniques, cloud chat interface, cloud merging, and digitally recycle these assets into carbon credits. Further, the system may provide intelligent cloud merging through automated IAC scripts.

Further, there is a way to streamline the process by using AI. The AI performs a number of functions including determining how much of the server is being used and identifying waste, and ways to optimize cloud spending through surfacing recommendations and data from the company's cloud. Infrastructure as a code is streamlined through IAC scripts as well as disaster recovery scripts. Further, the AI determines how much carbon emissions per metric ton are reduced from the reduced cloud infrastructure and carbon credit conversion. Further, the migration of one cloud environment to another is performed based on the infrastructure as code scripting. Further, the cloud chat interface that is enabled by LLM bots and AI autonomous agents using a chain of thoughts, allows DevOps resources within companies to perform more effectively by being able to ask questions regarding the companies' clouds and how to make configurations. Further, digital recycling is a feature that enables the system to convert the optimized cloud infrastructure into carbon credits through the calculation of reduced carbon emissions that are created from the optimization of the cloud infrastructure. The calculation may follow internationally recognized standards. Further, scripted disaster recovery is a feature that enables companies to have disaster recovery capabilities without the need to have duplicate infrastructure, but instead to have the capability to utilize a script that may automatically create a disaster recovery environment when needed. The method may enable companies to have a new technique for disaster recovery that may reduce carbon emissions because the companies may only spin up the environments through IAC scripts in the event of a disaster getting rid of the need for duplicate cloud environments both constantly running at the same time.

Further, the present disclosure describes that the optimization of underutilized resources may be digitally recycled into carbon credits for the offsets in carbon emissions as a result of the overall cloud optimization from automated disaster recovery scripts that may reduce the need for duplicated environments, merging of multi-cloud environments, and general optimization of oversized environments. These carbon credits may be digitally recycled or used by carbon traders or other companies that need them to offset the overage on the companies' carbon caps.

Further, the present disclosure describes the B2B model for managing clouds and converting optimized cloud infrastructure and reduction in emissions into Carbon Credits. Further, the B2B model includes the digital waste cleanup of CRM, and other 3rd party cloud cleanup along with AWS, Azure, Google, and converting these into carbon credits.

Further, the present disclosure describes the B2C model for managing devices (such as personal devices, mobile devices, etc.) and recycling unused and/or redundant digital assets of the devices into carbon credits. Further, the B2C model is for optimizing mobile devices (such as personal devices) and converting the reduction in personal emissions into carbon credits. Further, the unused and/or redundant digital assets may include junk email, duplicate photos and videos, etc.

Further, the present disclosure describes turning all forms of digital waste or reduction in energy consuming processes in cloud or data centers or personal devices into carbon credits not just cloud optimization (ex. CRM, Email, Photos, Videos, More Efficient Ways To Store Data, Data Center Optimization, Cloud Optimization, New Data Compression Techniques, Personal Device Efficiency and Personal Data Optimization, CRM, 3rd party optimization).

Further, the present disclosure describes a method for generating carbon credits from the reduction of energy consumption across various digital processes. Further, the method may include an application of artificial intelligence to optimize the efficiency of digital operations, including but not limited to cloud services, data centers, personal devices, and third-party systems. Further, the method may include an automatic identification and reduction of digital waste, including redundant data, inefficient storage methods, and underutilized computing resources. Further, the method may include an application of new data compression techniques, workload optimization algorithms, and storage efficiency strategies across various platforms (e.g., CRM systems, email services, video/photo storage, and personal device data). Further, the method may track and quantify energy savings resulting from the optimization of these processes and generate carbon credits based on the energy savings, wherein the carbon credits can be used, traded, or monetized to offset the environmental impact.

Further, the method describes a system and method for automating data migration across various infrastructure environments using artificial intelligence. Further, the system and method may include an AI-based engine configured to facilitate the seamless migration of workloads, applications, and data between different environments, including but not limited to cloud environments, physical data centers, and hybrid infrastructure. Further, the system and the method may include a capability to manage and execute migration processes such as merging multiple cloud environments, cloud-to-cloud migration, migration from physical data centers to cloud environments, and migration between data centers (whether on-premise, cloud-based or a combination of both). Further, the system and the method may make use of infrastructure as code (IaC) automation to recreate, scale, and optimize the migrated infrastructure in the target environment while preserving the functionality, performance, and security requirements of the original environment. Further, the AI-based engine continuously monitors and optimizes the migration process to minimize downtime, data loss, and resource usage and ensures that the migrated infrastructure is compliant with organizational and regulatory standards.

Further, the present disclosure describes a system and method for managing cloud infrastructure using autonomous AI-driven agents. Further, the system and the method may include a plurality of AI-based agents, each configured to autonomously handle distinct cloud management tasks, including but not limited to:
DevOps Automation Agent: Automates continuous integration/continuous deployment (CI/CD) pipeline management, infrastructure scaling, and rollback operations to optimize cloud deployment processes.
Cloud Resource Optimization Agent: Automatically optimizes cloud resource usage by identifying and deallocating underutilized resources, and autonomously shifting workloads to energy-efficient data centers.
Infrastructure as Code (IaC) Agent: Automatically generates, updates, and manages IAC scripts to ensure consistent cloud infrastructure provisioning and enable disaster recovery.
Governance & Security Agent: Enforces cloud compliance and security policies through automated auditing, access control management, and password reset processes.
Digital Sustainability Agent: Tracks cloud-related carbon emissions and autonomously shifts workloads to energy-efficient or renewable-powered data centers or eliminates digital waste to support sustainability objectives.
Cloud Architecture Insights Agent: Provides real-time optimization recommendations for cloud architecture and forecasts future resource demands to enhance performance and reduce costs.
Cloud Migration Agent: Automates the migration of workloads between cloud providers and from physical data centers to cloud environments, ensuring minimal downtime and preserving data integrity.

Further, each agent operates autonomously and in coordination with others to manage cloud infrastructure efficiently, reduce manual intervention, optimize resource usage, and improve overall system performance.

Further, the present disclosure describes a system and method for optimizing cloud-based data storage using artificial intelligence (AI). Further, the system and method may include:
A machine learning model configured to analyze digital content, including but not limited to videos, images, and documents.
An AI-based storage algorithm that converts the analyzed digital content into a custom byte format optimized for energy-efficient storage, wherein the AI-based algorithm can reconstruct the stored digital content back into its original form without loss of quality or user-perceptible differences, wherein the custom storage format reduces the energy required for storage and retrieval.
A carbon credit generation mechanism that measures the reduction in energy consumption and converts the savings into digital recycling outputs that can be monetized as carbon credits.

According to some embodiments, the present disclosure may facilitate Carbon Credit Trading. Accordingly, trading carbon credits generated from energy savings could open up a new revenue opportunities and promote green technology. Accordingly, the AI-driven cloud optimization disclosed herein may reduce energy usage, which may lead to the generation of carbon credits. Accordingly, the methods disclosed may include steps of generating carbon-credits and trading the carbon-credits on digital platforms like blockchain-based marketplaces. Accordingly, in an instance, the present disclosure provides a method for generating and trading carbon credits, including verifying energy savings, converting them into credits, and trading via a digital platform, with transaction data stored on a distributed ledger.

According to some embodiments, the present disclosure also provides AI Optimization. Accordingly, the methods and systems disclosed herein may perform real-time AI-driven optimization. Further, future iterations of AI models may be included in order to perform the AI driven techniques disclosed herein. Further, system may be configured to perform real-time, autonomous decisions for resource management. Additionally, the system may be configured to perform predictive, real-time AI optimizations. Accordingly, in an instance, the present disclosure provides a system for real-time optimization of cloud resources using AI, dynamically adjusting resources based on traffic, usage, and predictive modeling.

Further, the present disclosure also provides AI Optimization of AI Models for AI Processes consistent with the embodiments disclosed herein. Accordingly, optimizing AI models used in large-scale AI processes can reduce computational waste and improve the efficiency of these AI workflows. This may result in minimizing digital waste while enhancing performance across AI infrastructures. Accordingly, the methods disclosed herein may include AI optimization of AI models in these large-scale AI platforms leading to optimizing the efficiency of AI processes, reducing resource consumption and improving performance. Accordingly, in an instance, the present disclosure provides a method for using AI to optimize other AI models in large-scale AI processes, reducing resource consumption and improving performance across AI infrastructures.

Further, the present disclosure also provides Cloud Merging & Multi-Cloud Management in some embodiments. Accordingly, the methods disclosed herein may include automation of merging environments and/or techniques for handling workload redistribution. Accordingly, in an instance, the present disclosure provides a method for merging cloud platforms by automatically migrating workloads, addressing API differences, and optimizing performance across merged environments.

Further, the present disclosure also provides Energy-Efficient Compression/Storage Algorithms, according to some embodiments. Accordingly, the disclosed compression algorithms may help reduce energy use and tie directly into carbon credit generation. Accordingly, the methods disclosed herein lead to reduction of digital waste through efficient storage by using compression algorithms that drive these energy savings. Accordingly, in an instance, the present disclosure provides a method for optimizing cloud storage through energy-efficient compression and deduplication, dynamically adjusting storage to reduce energy consumption.

Further, the present disclosure also provides a Physical Device for Data Center Optimization. Accordingly, a physical AI-driven device may be provided that could implement the disclosed techniques in the data center optimization space and bridge the gap between cloud and on-premise systems. Accordingly, the present disclosure also provides a physical AI-driven device that monitors and optimizes energy usage and server performance in a data center, coordinating with cloud systems.

Further, the present disclosure also provides a Robotic AI in Data Center Management. Accordingly, Robotic AI could automate physical maintenance of data center infrastructure, aligning with industry trends. Accordingly, the present disclosure provides a robotic AI system for managing data center infrastructure, maintaining servers, cooling systems, and power distribution autonomously.

Further, the present disclosure also provides Edge Computing and IoT Futureproofing. Accordingly, the present disclosure may provide a system for managing resources across edge devices and IoT, dynamically allocating workloads between edge systems and cloud infrastructure.

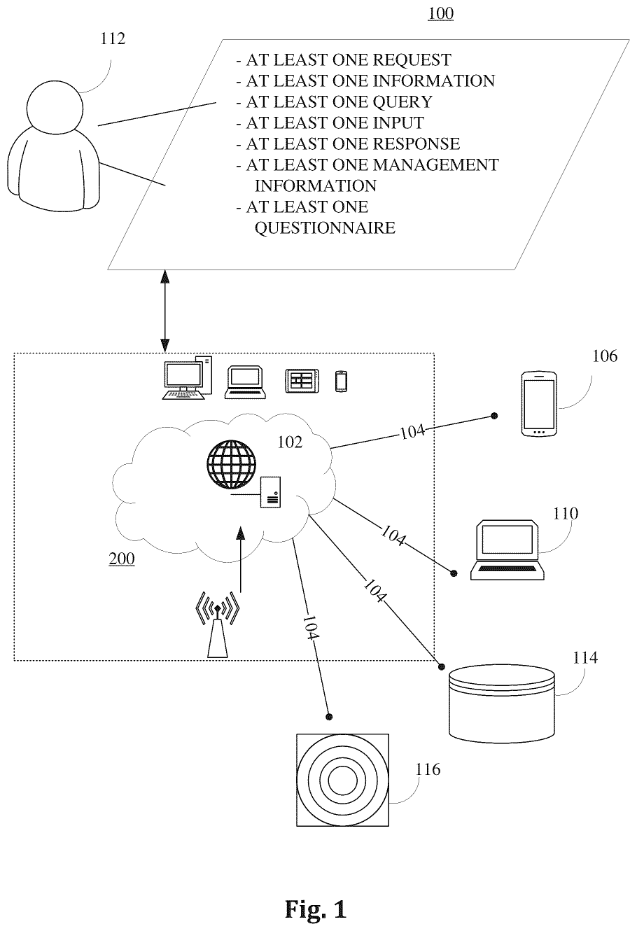

FIG. 1 is an illustration of an online platform 100 consistent with various embodiments of the present disclosure. By way of non-limiting example, the online platform 100 to facilitate managing clouds for a user may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

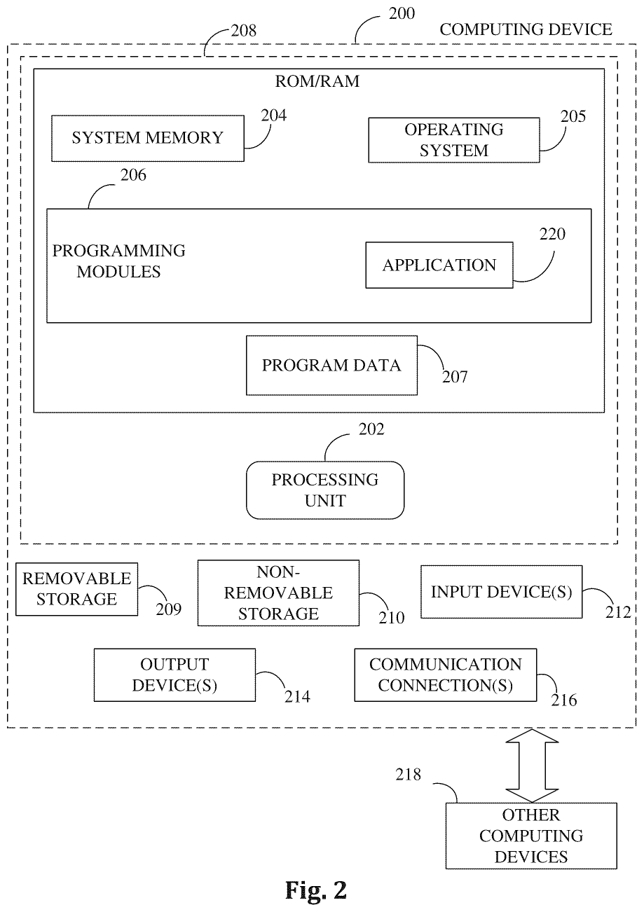

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

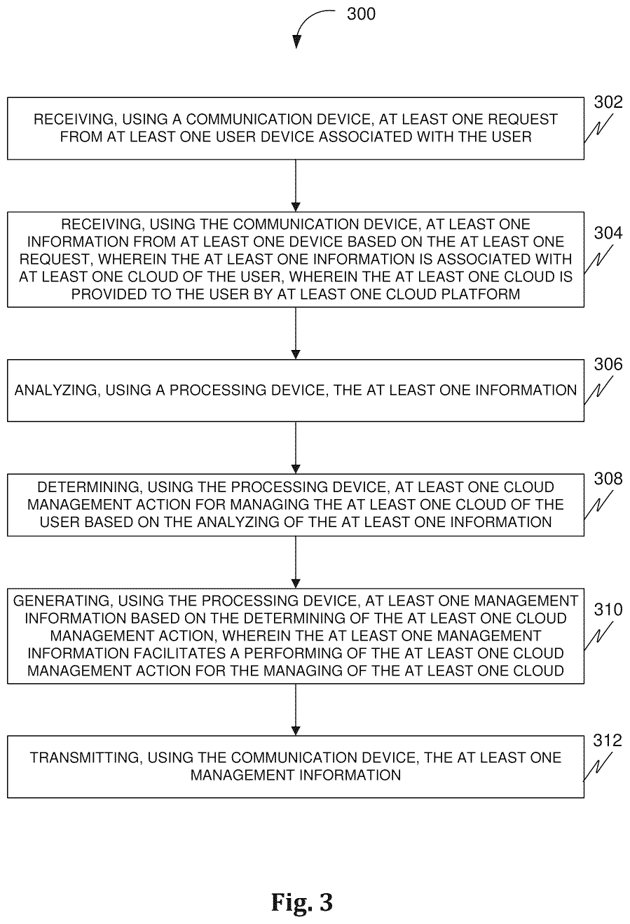

FIG. 3 illustrates a flowchart of a method 300 for facilitating managing clouds for a user, in accordance with some embodiments.

Accordingly, the method 300 may include a step 302 of receiving, using a communication device 1202, one or more requests from one or more user devices (such as one or more user devices 1302) associated with the user. Further, the one or more requests may include a request for saving on a cloud bill for the clouds of the user, a request to merge the clouds of the user, a request for setting up the clouds, a request for cloning the clouds, a request for migrating the clouds, a query associated with the clouds, etc. Further, the one or more user devices may include a client device, a user device, a computing device, etc. Further, the one or more requests may include one or more identifiers, one or more permissions for accessing the cloud, etc. Further, the one or more requests may include one or more account data of one or more accounts associated with the user. Further, the user may include an individual, an institution, an organization, etc.

Further, the method 300 may include a step 304 of receiving, using the communication device 1202, one or more information from one or more devices (such as one or more devices 1304) based on the one or more requests. Further, the one or more information may be associated with one or more clouds of the user. Further, the one or more clouds may be provided to the user by one or more cloud platforms. Further, the receiving of the one or more information may include scanning the one or more clouds based on the one or more requests. Further, the receiving of the one or more information may include obtaining the one or more information from the one or more clouds based on the scanning. Further, the one or more information may include a cloud usage information associated with a usage of the one or more clouds by the user, a resource allocation information associated with an allocation of one or more cloud resources to the user, a resource utilization information associated with a utilization of the one or more cloud resources by the one or more user, etc. Further, the one or more information may be associated with one or more cloud environments of the user. Further, the one or more information may be associated with one or more cloud infrastructures of the user. Further, the one or more devices may include a client device, a user device, a computing device, etc. Further, the one or more devices may include cloud platform devices associated with the one or more cloud platforms. Further, the one or more clouds may be hosted on the one or more devices.

Further, the method 300 may include a step 306 of analyzing, using a processing device 1204, the one or more information. Further, the analyzing of the one or more information may include analyzing the one or more information using one or more machine learning models. Further, the one or more information may include one or more digital content (such as videos, images, and documents, etc.) associated with the one or more clouds.

Further, the method 300 may include a step 308 of determining, using the processing device 1204, one or more cloud management actions for managing the one or more clouds of the user based on the analyzing of the one or more information. Further, the determining of the one or more cloud management actions may be based on the one or more requests. Further, the one or more cloud management actions may include a cloud optimizing action (such as a scaling up of a cloud resource, a scaling back of a cloud resource, an addition of a cloud resource, a removal of a cloud resource, etc.) a cloud migrating action, a cloud merging action, a cloud decommissioning action, a cloud porting action, etc. Further, the one or more cloud management actions may include migration of workloads, applications, and data between different environments, including but not limited to cloud environments, physical data centers, and hybrid infrastructure.

Further, the method 300 may include a step 310 of generating, using the processing device 1204, one or more management information based on the determining of the one or more cloud management actions. Further, the one or more management information facilitates a performing of the one or more cloud management actions for the managing of the one or more clouds. Further, the performing of the one or more management actions may include executing migration processes such as merging multiple cloud environments, cloud-to cloud migration, migration from physical data centers to cloud environments, and migration between data centers (whether on-premise, cloud-based or a combination of both). Further, the method 300 may include a step 312 of transmitting, using the communication device 1202, the one or more management information. Further, the one or more management information may include one or more scripts and one or more instructions. Further, the performing of the one or more cloud management actions may be based on the one or more scripts and the one or more management instructions. Further, the one or more scripts may include infrastructure as code (IaC) scripts, etc. Further, the transmitting of the one or more management information may include transmitting the one or more management information to one or more cloud platforms, one or more cloud service provider devices, one or more external devices, the one or more user devices, the one or more devices, etc. Further, in an embodiment, the method 300 may include performing, using the processing device 1204, the one or more cloud management actions based on the one or more management information. Further, the performing of the one or more cloud management actions may include converting the one or more digital content into a custom byte format optimized for energy-efficient storage using an AI-based storage algorithm. Further, the AI-based algorithm may reconstruct the one or more digital content back into an original format without loss of quality or user-perceptible differences from the custom byte format. Further, the converting of the one or more digital content into the custom byte format reduces the energy required for storage and retrieval. Further, in an embodiment, the method 300 may include converting, using the processing device 1204, a reduction in the energy consumption associated with the performing of the one or more cloud management actions by measuring a reduction in the energy consumption, into a digital recycling output. Further, the digital recycling output may be monetized as carbon credits. Further, in an embodiment, the method 300 may include performing, using the processing device 1204, the one or more cloud management actions based on the one or more management information. Further, the performing of the one or more cloud management actions may include an application of artificial intelligence (such as an ML model, etc.) to optimize an efficiency of digital operations, including but not limited to cloud services, an automatic identification and reduction of digital waste, including redundant data, inefficient storage methods, and underutilized computing resources, and an application of data compression techniques, workload optimization algorithms, and storage efficiency strategies across the one or more cloud platforms. Further, the performing of the one or more cloud management actions involves tracking and quantifying energy savings resulting from the optimization of processes associated with the one or more clouds, and generating carbon credits based on energy savings associated with the one or more clouds. Further, the carbon credits may be used, traded, or monetized to offset environmental impact.

In some embodiments, the one or more information may include a charging rate of one or more cloud platforms. Further, the one or more devices may include a computing device. Further, the one or more user devices may include a laptop, a desktop, a tablet, etc. Further, the one or more management information may be generated periodically.

Further, in some embodiment, the method 300 may include a step of creating, using the processing device 1204, one or more artificial intelligent autonomous agents based on the determining of the one or more cloud management actions. Further, the one or more artificial intelligent autonomous agents may be configured for autonomously handling one or more tasks associated with the one or more cloud management actions based on the one or more management information. Further, the one or more artificial intelligent autonomous agents may include a DevOps automation agent, a cloud resource optimization agent, an Infrastructure as Code (IaC) agent, a governance & security agent, a digital sustainability agent, a cloud architecture insights agent, a cloud migration agent, etc. Further, the one or more artificial intelligent autonomous agents execute the one or more cloud management actions based on the handling of the one or more tasks.

Further, in some embodiments, the one or more clouds may be synchronized with one or more external devices. Further, the one or more external devices may include one or more personal devices (such as user devices, client devices, computing devices, etc.), datacenters, etc. Further, the one or more external devices may be associated with one or more platforms.

Further, the one or more platforms may include customer relationship management (CRM) platforms, 3rd party platforms, external Software as a Service (SaaS) platforms, etc. Further, the method 300 may include a step of determining, using the processing device 1204, one or more device management actions for the one or more external devices based on the determining of the one or more cloud management actions. Further, the one or more device management actions may include migrating workloads, applications, and data from the one or more external devices to one or more cloud environments, migrating workloads, applications, and data from the one or more external devices to one or more another external devices, merging workloads, applications, and data of two or more external devices into one external device, etc. Further, the generating of the one or more management information may be based on the determining of the one or more device management actions. Further, the one or more management information facilitates a performing of the one or more device management actions for the managing of the one or more external devices. Further, the method 300 may include performing, using the processing device 1204, the one or more device management actions based on the one or more management information. Further, in an embodiment, the method 300 may include performing, using the processing device 1204, the one or more device management actions based on the one or more management information. Further, the performing of the one or more device management actions may include an application of artificial intelligence (such as an ML model, etc.) to optimize an efficiency of digital operations, including but not limited to data centers, personal devices, and third-party systems, an automatic identification and reduction of digital waste, including redundant data, inefficient storage methods, and underutilized computing resources, and an application of data compression techniques, workload optimization algorithms, and storage efficiency strategies across the platforms, the data centers, the personal devices, and the third-party systems. Further, the performing of the one or more device management actions involves tracking and quantifying energy savings resulting from the optimization of processes associated with the one or more external devices, and generating carbon credits based on energy savings associated with the one or more external devices. Further, the carbon credits may be used, traded, or monetized to offset environmental impact.

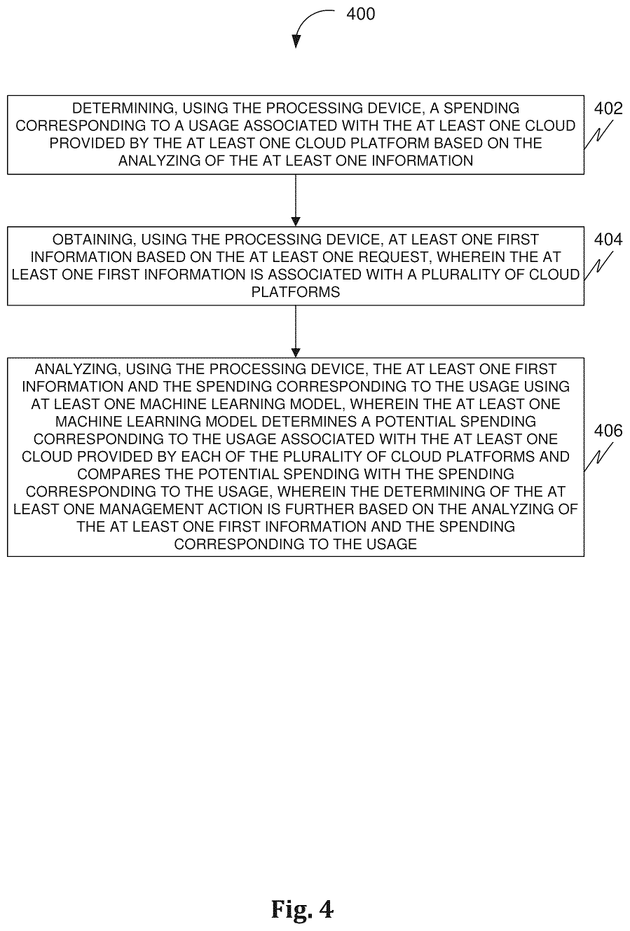

FIG. 4 illustrates a flowchart of a method 400 for facilitating managing clouds for a user including analyzing, using the processing device 1204, the at least one first information and the spending corresponding to the usage using at least one machine learning model, in accordance with some embodiments.

Further, in some embodiments, the method 400 further may include a step 402 of determining, using the processing device 1204, a spending corresponding to a usage associated with the one or more clouds provided by the one or more cloud platforms based on the analyzing of the one or more information. Further, in some embodiments, the method 400 may include a step 404 of obtaining, using the processing device 1204, one or more first information based on the one or more requests. Further, the one or more first information may be associated with two or more cloud platforms. Further, the two or more first information may include two or more pricing models of the two or more cloud platforms, two or more cloud resource types of the two or more cloud platforms, two or more cloud services provided by the two or more cloud platforms, two or more compliances for the two or more cloud platforms, etc. Further, in some embodiments, the method 400 further may include a step 406 of analyzing, using the processing device 1204, the one or more first information and the spending corresponding to the usage using one or more machine learning models. Further, the one or more machine learning models determine a potential spending corresponding to the usage associated with the one or more clouds provided by each of the two or more cloud platforms and compare the potential spending with the spending corresponding to the usage. Further, the determining of the one or more management actions may be based on the analyzing of the one or more first information and the spending corresponding to the usage. Further, the one or more machine learning models may include a regression neural network model and a classification neural network model. Further, the one or more machine learning models may include at least one neural network. Further, the at least one neural network may include a convolutional neural network, a recurrent neural network, a transformer network, etc. Further, the one or more machine learning models may include at least one encoder. Further, the one or more machine learning model a transformer model, a generative pre-trained transformer, a Bidirectional Encoder Representations from Transformer (BERT), a Bidirectional and Auto-Regressive Transformer (BART), etc.

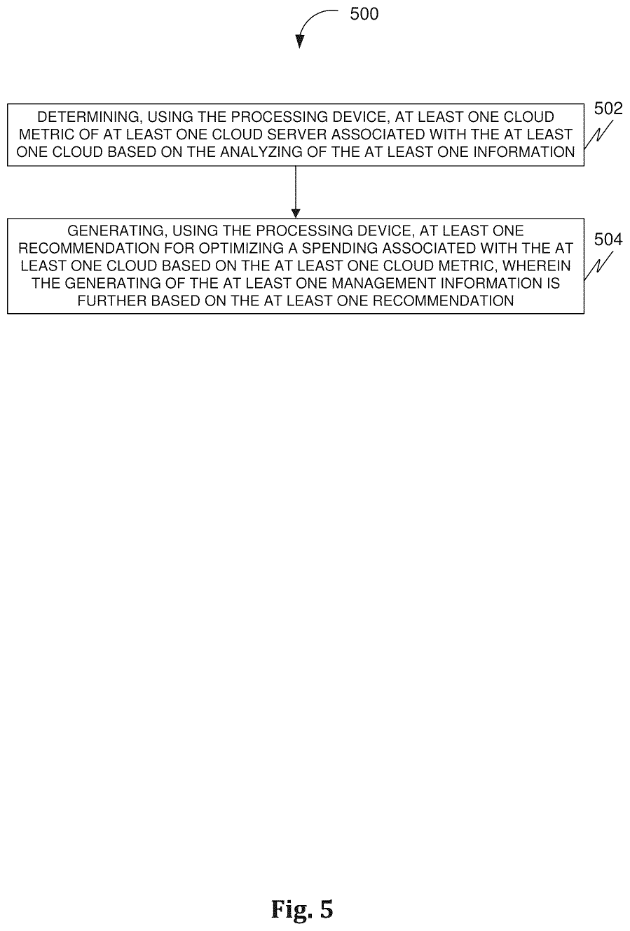

FIG. 5 illustrates a flowchart of a method 500 for facilitating managing clouds for a user including generating, using the processing device 1204, at least one recommendation for optimizing a spending associated with the at least one cloud, in accordance with some embodiments.

Further, in some embodiments, the method 500 may include a step 502 of determining, using the processing device 1204, one or more cloud metrics of one or more cloud servers associated with the one or more clouds based on the analyzing of the one or more information. Further, in some embodiments, the method 500 may include a step 504 of generating, using the processing device 1204, one or more recommendations for optimizing a spending associated with the one or more clouds based on the one or more cloud metrics. Further, the generating of the one or more management information may be based on the one or more recommendations. Further, the one or more cloud metrics may be for a usage associated with the one or more clouds of the user. Further, the one or more cloud metrics may include processor usage metrics, memory usage metrics, network usage metrics, input-output usage metrics, disk usage metrics, application usage metrics, etc.

In some embodiments, the one or more cloud metrics may be associated with utilization of a cloud resource. Further, the one or more recommendations may include a message associated with optimization of expenditure on the one or more clouds.

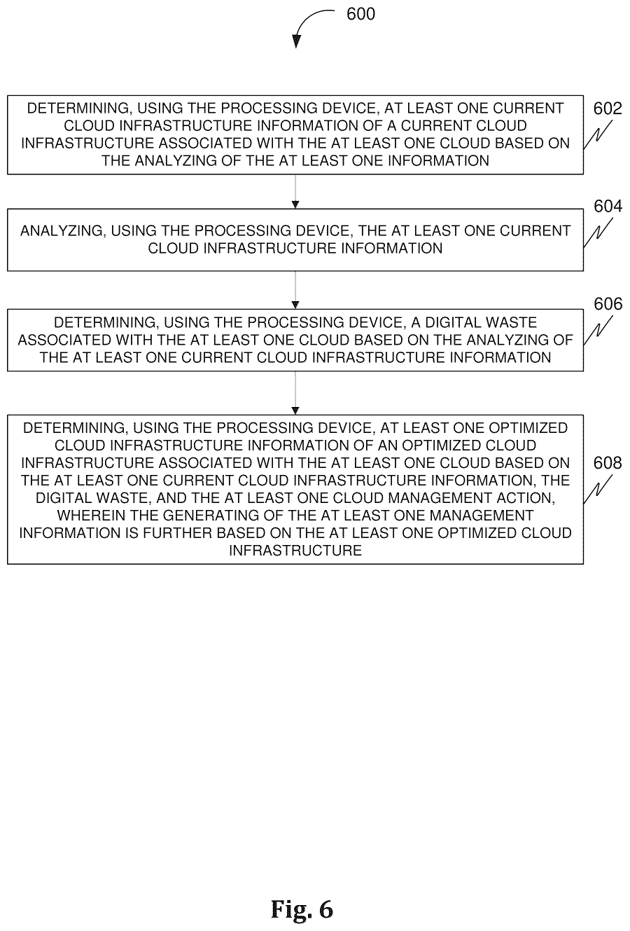

FIG. 6 illustrates a flowchart of a method 600 for facilitating managing clouds for a user including determining, using the processing device 1204, at least one optimized cloud infrastructure information of an optimized cloud infrastructure associated with the at least one cloud, in accordance with some embodiments.

Further, in some embodiments, the method 600 may include a step 602 of determining, using the processing device 1204, one or more current cloud infrastructure information of a current cloud infrastructure associated with the one or more clouds based on the analyzing of the one or more information. Further, in some embodiments, the method 600 may include a step 604 of analyzing, using the processing device 1204, the one or more current cloud infrastructure information. Further, in some embodiments, the method 600 may include a step 606 of determining, using the processing device 1204, a digital waste associated with the one or more clouds based on the analyzing of the one or more current cloud infrastructure information. Further, in some embodiments, the method 600 may include a step 608 of determining, using the processing device 1204, one or more optimized cloud infrastructure information of an optimized cloud infrastructure associated with the one or more clouds based on the one or more current cloud infrastructure information, the digital waste, and the one or more cloud management actions. Further, the generating of the one or more management information may be based on the one or more optimized cloud infrastructures.

Further, the method 600 describes an ability to manage and optimize cloud infrastructure and digital waste across various platforms, including but not limited to AWS, Azure, Google Cloud, Salesforce, Kubernetes, Atlassian, and third-party services (e.g., CRM systems, external SaaS platforms). Further, the managing and the optimizing of the infrastructure and digital waste across various platforms include detection and removal of digital waste, including underutilized resources, redundant data, and inefficient configurations, data storage, and files not limited to (Videos, Images, Files), and converting the reduction in energy consumption and emissions from these optimizations into carbon credits that can be traded, monetized, or offset to meet sustainability goals.

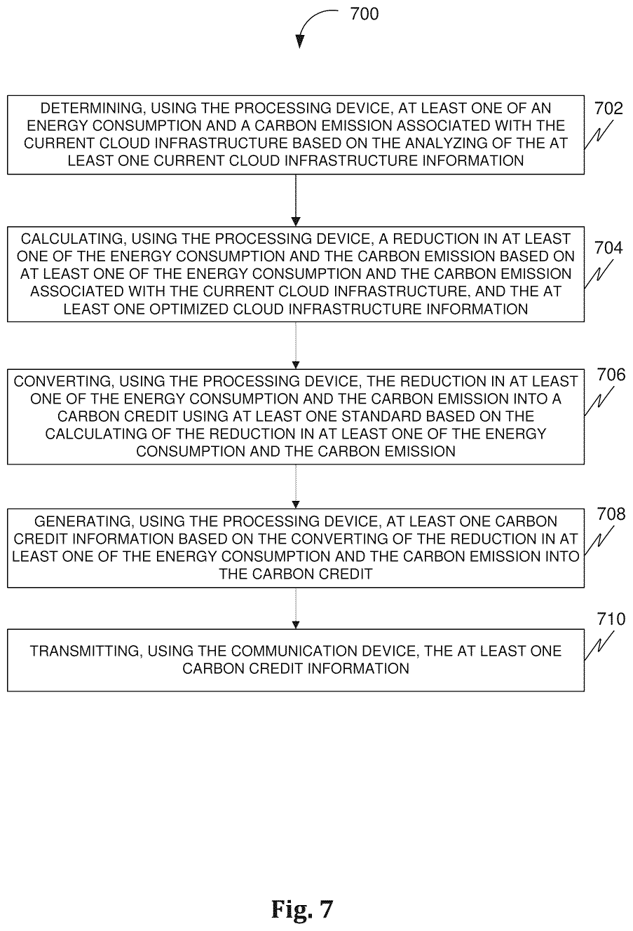

FIG. 7 illustrates a flowchart of a method 700 for facilitating managing clouds for a user including calculating, using the processing device 1204, a reduction in the carbon emission, in accordance with some embodiments.

Further, in some embodiments, the method 700 may include a step 702 of determining, using the processing device 1204, one or more of an energy consumption and a carbon emission associated with the current cloud infrastructure based on the analyzing of the one or more current cloud infrastructure information. Further, in some embodiments, the method 700 may include a step 704 of calculating, using the processing device 1204, a reduction in one or more of the energy consumption and the carbon emission based on one or more of the energy consumption and the carbon emission associated with the current cloud infrastructure, and the one or more optimized cloud infrastructure information. Further, in some embodiments, the method 700 may include a step 706 of converting, using the processing device 1204, the reduction in one or more of the energy consumption and the carbon emission into a carbon credit using one or more standards based on the calculating of the reduction in one or more of the energy consumption and the carbon emission. Further, in some embodiments, the method 700 may include a step 708 of generating, using the processing device 1204, one or more carbon credit information based on the converting of the reduction in one or more of the energy consumption and the carbon emission into the carbon credit. Further, in some embodiments, the method 700 may include a step 710 of transmitting, using the communication device 1202, the one or more carbon credit information. Further, in some embodiments, the carbon credit may be associated with a value. Further, the method 700 may include minting, using the processing device 1204, one or more non fungible tokens based on the carbon credit. Further, each of the one or more non fungible tokens may be associated with a token value corresponding to at least one a portion of the value of the carbon credit. Further, at least one of the carbon credit and the one or more non fungible tokens may be traded, sold, transferred, etc.

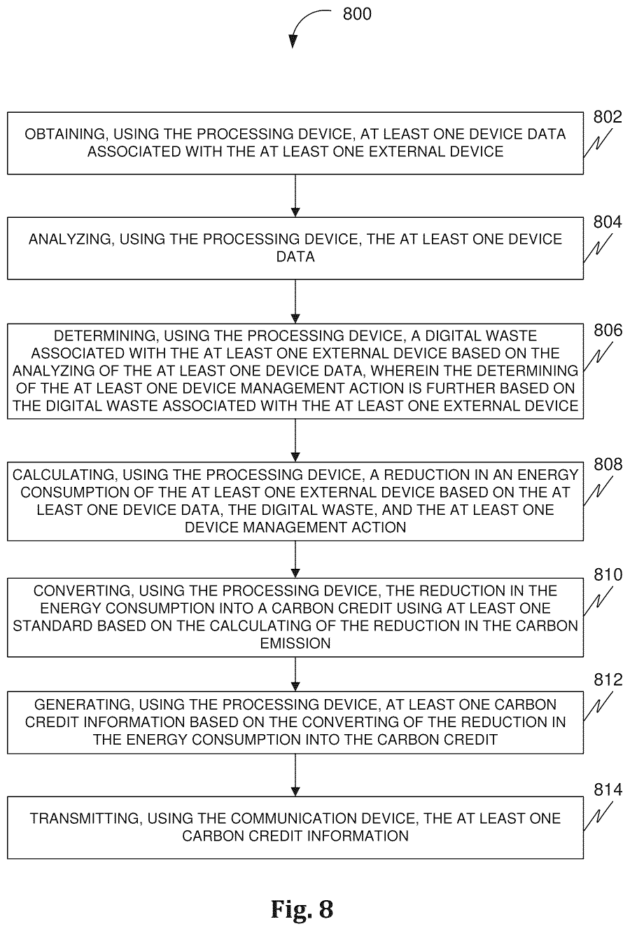

FIG. 8 illustrates a flowchart of a method 800 for facilitating managing clouds for a user including generating, using the processing device 1204, at least one carbon credit information based on the converting of the reduction in the energy consumption into the carbon credit, in accordance with some embodiments.

Further, in some embodiments, the method 800 may include a step 802 of obtaining, using the processing device 1204, one or more device data associated with the one or more external devices. Further, in some embodiments, the method 800 may include a step 804 of analyzing, using the processing device 1204, the one or more device data. Further, in some embodiments, the method 800 may include a step 806 of determining, using the processing device, a digital waste associated with the one or more external devices based on the analyzing of the one or more device data. Further, the determining of the one or more device management actions may be based on the digital waste associated with the one or more external devices. Further, in some embodiments, the method 800 may include a step 808 of calculating, using the processing device 1204, a reduction in an energy consumption of the one or more external devices based on the one or more device data, the digital waste, and the one or more device management actions. Further, in some embodiments, the method 800 further may include a step 810 of converting, using the processing device 1204, the reduction in the energy consumption into a carbon credit using one or more standards based on the calculating of the reduction in the carbon emission. Further, in some embodiments, the method 800 may include a step 812 of generating, using the processing device 1204, one or more carbon credit information based on the converting of the reduction in the energy consumption into the carbon credit. Further, in some embodiments, the method 800 may include a step 814 of transmitting, using the communication device 1202, the one or more carbon credit information.

Further, the method 800 describes an ability to optimize personal devices such as mobile phones, tablets, and personal computers by identifying and cleaning up unnecessary data, such as junk emails, duplicate photos, videos, and other redundant files, or energy consuming processes that are not necessary to be running. Further, the optimization of the personal devices may include tracking and reducing the energy consumption of these personal devices, and converting the reduction in emissions from optimized device usage into carbon credits for individual users, allowing them to trade or use the credits to offset their personal carbon footprint.

In some embodiments, the one or more carbon credits may include a token received from an external enterprise. Further, the one or more carbon credits may be sold or traded. Further, the one or more standards may be accepted internationally.

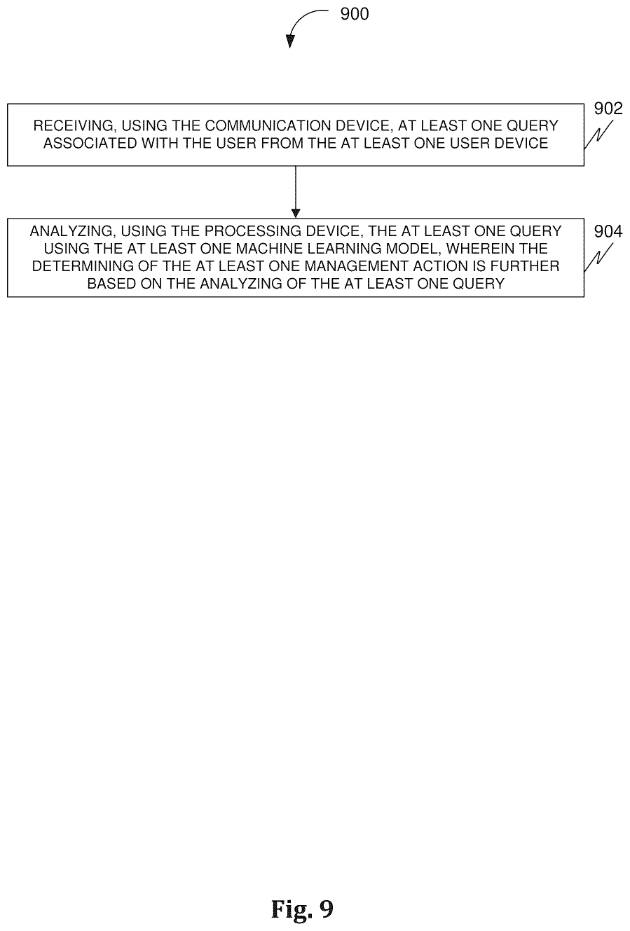

FIG. 9 illustrates a flowchart of a method 900 for facilitating managing clouds for a user including analyzing, using the processing device 1204, the at least one query using the at least one machine learning model, in accordance with some embodiments.

Further, in some embodiments, the analyzing of the one or more information may include tuning one or more machine learning models using the one or more information. Further, the one or more machine learning models may include one or more pre-trained machine learning models. Further, the one or more pre-trained machine learning models may include one or more large language models. Further, the method 900 may include a step 902 of receiving, using the communication device 1202, one or more queries associated with the user from the one or more user devices. Further, the method 900 may include a step 904 of analyzing, using the processing device 1204, the one or more queries using the one or more machine learning models. Further, the determining of the one or more management actions may be based on the analyzing of the one or more queries.

In some embodiments, the one or more management information may be configured for initiating the one or more management actions based on a condition.

In some embodiments, the one or more conditions may be associated with a disaster associated with a cloud environment, a cloud, etc associated with the user. Further, the disaster may require generation of a cloud environment using an Infrastructure as a Code script.

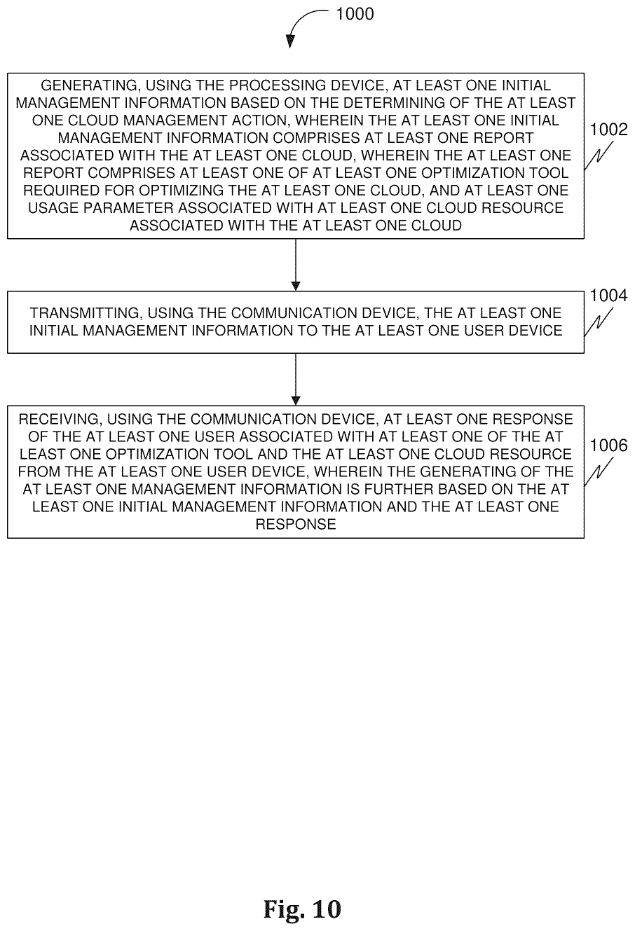

FIG. 10 illustrates a flowchart of a method 1000 for facilitating managing clouds for a user including receiving, using the communication device 1202, at least one response of the at least one user associated with at least one of the at least one optimization tool and the at least one cloud resource from the at least one user device, in accordance with some embodiments.

Further, in some embodiments, the method 1000 may include a step 1002 of generating, using the processing device 1204, one or more initial management information based on the determining of the one or more cloud management actions. Further, the one or more initial management information includes one or more reports associated with the one or more clouds. Further, the one or more reports include one or more of one or more optimization tools required for optimizing the one or more clouds, and one or more usage parameters associated with one or more cloud resources associated with the one or more clouds. Further, in some embodiments, the method 1000 may include a step 1004 of transmitting, using the communication device 1202, the one or more initial management information to the one or more user devices. Further, in some embodiments, the method 1000 may include a step 1006 of receiving, using the communication device 1202, one or more responses of the one or more users associated with one or more of the one or more optimization tools and the one or more cloud resources from the one or more user devices. Further, the generating of the one or more management information may be based on the one or more initial management information and the one or more responses.

In some embodiments, the one or more reports may include information associated with an under-utilization of the one or more cloud resources. Further, the one or more responses may associated with the one or more cloud resources that the one or more users want to keep.

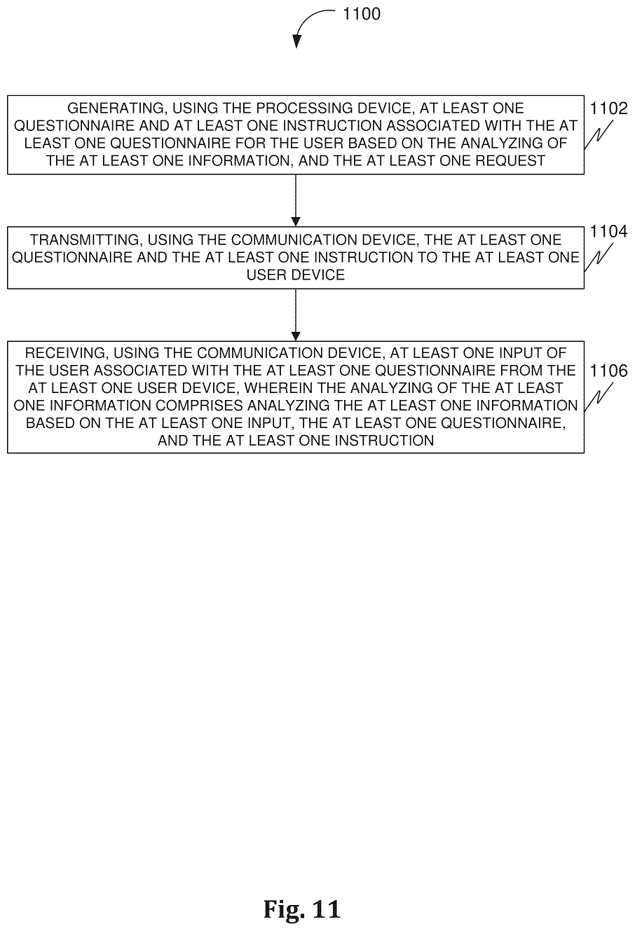

FIG. 11 illustrates a flowchart of a method 1100 for facilitating managing clouds for a user including receiving, using the communication device 1202, at least one input of the user associated with the at least one questionnaire from the at least one user device, in accordance with some embodiments.

Further, in some embodiments, the method 1100 may include a step 1102 of generating, using the processing device 1204, one or more questionnaires and one or more instructions associated with the one or more questionnaires for the user based on the analyzing of the one or more information, and the one or more requests. Further, in some embodiments, the method 1100 may include a step 1104 of transmitting, using the communication device 1202, the one or more questionnaires and the one or more instructions to the one or more user devices. Further, in some embodiments, the method 1100 may include a step 1106 of receiving, using the communication device 1202, one or more inputs of the user associated with the one or more questionnaires from the one or more user devices. Further, the analyzing of the one or more information includes analyzing the one or more information based on the one or more inputs, the one or more questionnaires, and the one or more instructions.

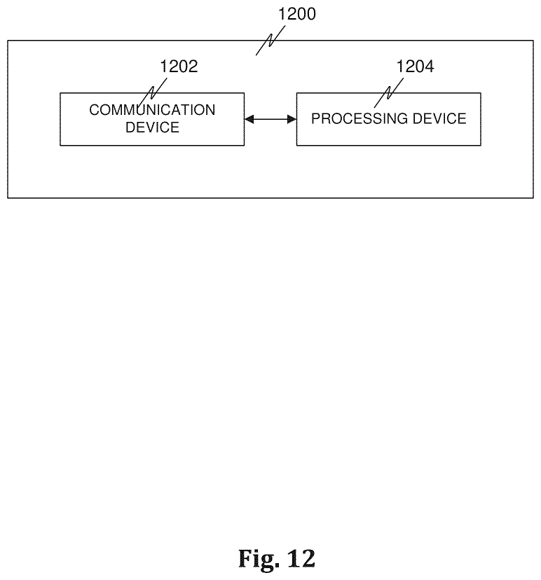

FIG. 12 illustrates a block diagram of a system 1200 for facilitating managing clouds for a user, in accordance with some embodiments.

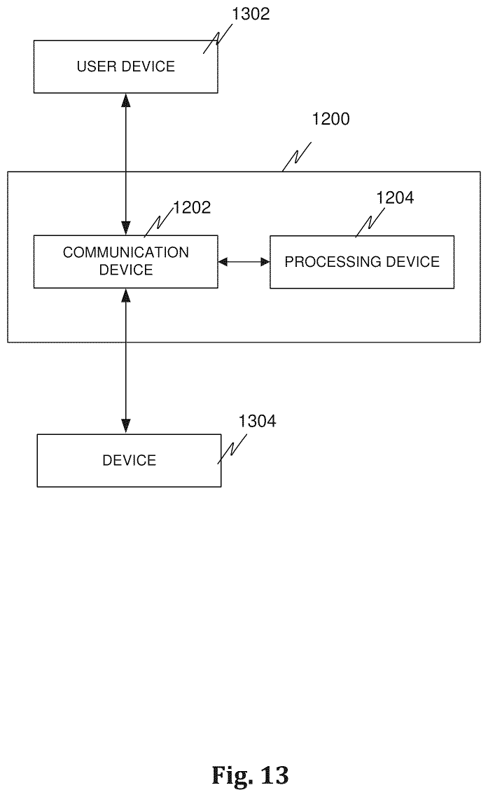

Accordingly, the system 1200 may include a communication device 1202. Further, the communication device 1202 may be configured for receiving one or more requests from one or more user devices 1302, as shown in FIG. 13, associated with the user. Further, the communication device 1202 may be configured for receiving one or more information from one or more devices 1304, as shown in FIG. 13, based on the one or more requests. Further, the one or more information may be associated with one or more clouds of the user. Further, the one or more clouds may be provided to the user by one or more cloud platforms. Further, the communication device 1202 may be configured for transmitting one or more management information. Further, the system 1200 may include a processing device 1204 communicatively coupled with the communication device 1202. Further, the processing device 1204 may be configured for analyzing the one or more information. Further, the processing device 1204 may be configured for determining one or more cloud management actions for managing the one or more clouds of the user based on the analyzing of the one or more information. Further, the processing device 1204 may be configured for generating the one or more management information based on the determining of the one or more cloud management actions. Further, the one or more management information facilitates a performing of the one or more cloud management actions for the managing of the one or more clouds.

Further, in some embodiments, the processing device 1204 may be configured for determining a spending corresponding to a usage associated with the one or more clouds provided by the one or more cloud platforms based on the analyzing of the one or more information. Further, the processing device 1204 may be configured for obtaining one or more first information based on the one or more requests. Further, the one or more first information may be associated with two or more cloud platforms. Further, the processing device 1204 may be further configured for analyzing the one or more first information and the spending corresponding to the usage using one or more machine learning models. Further, the one or more machine learning models determine a potential spending corresponding to the usage associated with the one or more clouds provided by each of the two or more cloud platforms and compare the potential spending with the spending corresponding to the usage. Further, the determining of the one or more management actions may be based on the analyzing of the one or more first information and the spending corresponding to the usage.

Further, in some embodiments, the processing device 1204 may be configured for determining one or more cloud metrics of one or more cloud servers associated with the one or more clouds based on the analyzing of the one or more information. Further, the processing device 1204 may be configured for generating one or more recommendations for optimizing a spending associated with the one or more clouds based on the one or more cloud metrics. Further, the generating of the one or more management information may be based on the one or more recommendations.

Further, in some embodiments, the processing device 1204 may be configured for determining one or more current cloud infrastructure information of a current cloud infrastructure associated with the one or more clouds based on the analyzing of the one or more information. Further, the processing device 1204 may be configured for analyzing the one or more current cloud infrastructure information. Further, the processing device 1204 may be configured for determining a digital waste associated with the one or more clouds based on the analyzing of the one or more current cloud infrastructure information. Further, the processing device 1204 may be configured for determining one or more optimized cloud infrastructure information of an optimized cloud infrastructure associated with the one or more clouds based on the one or more current cloud infrastructure information, the digital waste, and the one or more cloud management actions. Further, the generating of the one or more management information may be based on the one or more optimized cloud infrastructures.

Further, in some embodiments, the processing device 1204 may be configured for determining one or more of an energy consumption and a carbon emission associated with the current cloud infrastructure based on the analyzing of the one or more current cloud infrastructure information. Further, the processing device 1204 may be configured for calculating a reduction in one or more of the energy consumption and the carbon emission based on one or more of the energy consumption and the carbon emission associated with the current cloud infrastructure, and the one or more optimized cloud infrastructure information. Further, the processing device 1204 may be configured for converting the reduction in one or more of the energy consumption and the carbon emission into a carbon credit using one or more standards based on the calculating of the reduction in one or more of the energy consumption and the carbon emission. Further, the processing device 1204 may be configured for generating one or more carbon credit information based on the converting of the reduction in the carbon emission into the carbon credit. Further, the communication device 1202 may be configured for transmitting the one or more carbon credit information.

Further, in some embodiments, the processing device 1204 may be configured for creating one or more artificial intelligent autonomous agents based on the determining of the one or more cloud management actions. Further, the one or more artificial intelligent autonomous agents may be configured for autonomously handling one or more tasks associated with the one or more cloud management actions based on the one or more management information.

Further, in some embodiments, the one or more clouds may be synchronized with one or more external devices. Further, the processing device 1204 may be configured for determining one or more device management actions for the one or more external devices based on the determining of the one or more cloud management actions. Further, the generating of the one or more management information based on the determining of the one or more device management actions. Further, the one or more management information facilitates a performing of the one or more device management actions for the managing of the one or more external devices.

Further, in some embodiments, the processing device 1204 may be configured for obtaining one or more device data associated with the one or more external devices. Further, the processing device 1204 may be configured for analyzing the one or more device data. Further, the processing device 1204 may be configured for determining a digital waste associated with the one or more external devices based on the analyzing of the one or more device data. Further, the determining of the one or more device management actions may be based on the digital waste associated with the one or more external devices. Further, the processing device 1204 may be configured for calculating a reduction in an energy consumption of the one or more external devices based on the one or more device data, the digital waste, and the one or more device management actions. Further, the processing device 1204 may be configured for converting the reduction in the energy consumption into a carbon credit using one or more standards based on the calculating of the reduction in the carbon emission. Further, the processing device 1204 may be configured for generating one or more carbon credit information based on the converting of the reduction in the energy consumption into the carbon credit. Further, the communication device 1204 may be configured for transmitting the one or more carbon credit information.

In some embodiments, the analyzing of the one or more information includes tuning one or more machine learning models using the one or more information. Further, the communication device 1202 may be configured for receiving one or more queries associated with the user from the one or more user devices 1302. Further, the processing device 1204 may be configured for analyzing the one or more queries using the one or more machine learning models. Further, the determining of the one or more management actions may be based on the analyzing of the one or more queries.

In some embodiments, the one or more management information may be configured for initiating the one or more management actions based on a condition.

Further, in some embodiments, the processing device 1204 may be configured for generating one or more initial management information based on the determining of the one or more cloud management actions. Further, the one or more initial management information may include one or more reports associated with the one or more clouds. Further, the one or more reports may include one or more of one or more optimization tools required for optimizing the one or more clouds, and one or more usage parameters associated with one or more cloud resources associated with the one or more clouds. Further, the communication device 1202 may be configured for transmitting the one or more initial management information to the one or more user devices 1302. Further, the one or more initial management information may include one or more reports associated with the one or more clouds. Further, the communication device 1202 may be configured for receiving one or more responses of the one or more users associated with one or more of the one or more optimization tools and the one or more cloud resources from the one or more user devices 1302. Further, the generating of the one or more management information may be based on the one or more initial management information and the one or more responses.

Further, in some embodiments, the processing device 1204 may be configured for generating one or more questionnaires and one or more instructions associated with the one or more questionnaires for the user based on the analyzing of the one or more information, and the one or more requests. Further, the communication device 1202 may be configured for transmitting the one or more questionnaires and the one or more instructions to the one or more user devices 1302. Further, the communication device 1202 may be configured for receiving one or more inputs of the user associated with the one or more questionnaires from the one or more user devices 1302. Further, the analyzing of the one or more information includes analyzing the one or more information based on the one or more inputs, the one or more questionnaires, and the one or more instructions.

FIG. 13 illustrates a block diagram of the system 1200 for facilitating managing the clouds for the user, in accordance with some embodiments.

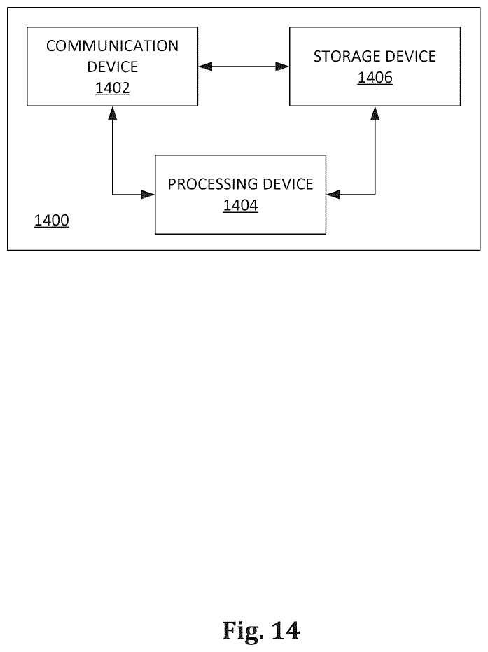

FIG. 14 is a block diagram of a system 1400 for facilitating cloud optimization, in accordance with some embodiments. Accordingly, the system 1400 may include a communication device 1402, a processing device 1404, and a storage device 1406. Further, the storage device 1406 may be communicatively coupled with the processing device 1404. Further, the storage device 1406 may be communicatively coupled with the communication device 1402. Further, the communication 1402 device may be communicatively coupled with the processing device 1404.

Further, the communication device 1402 may be configured for receiving a plurality of data storage information associated with a plurality of cloud computing platforms from a client device associated with a client. Further, the plurality of data storage information may include, but may not be limited to, a plurality of payment statements associated with a plurality of services provided by the plurality of cloud computing platforms to the client, utilization information associated with the plurality of services, etc. Further, the plurality of cloud computing platforms may include, but may not be limited to, AWS, Azure, and Google Clouds. Further, the communication device 1402 may be configured for transmitting at least one validation prompt to the client device. Further, the communication device 1402 may be configured for receiving at least one prompt response corresponding to the at least one validation prompt from the client device. Further, the at least one prompt response may include an acceptance of at least one cost-reducing tool and at least one economical cloud computing platform by the client. Further, the at least one prompt response may include a rejection of the at least one cost-reducing tool and the at least one economical cloud computing platform by the client. Further, the communication device 1402 may be configured for transmitting a plurality of optimization instructions to the client device.

Further, the processing device 1404 may be configured for analyzing the plurality of data storage information. Further, the processing device 1404 may be configured for comparing a plurality of economical cloud computing information and the plurality of data storage information. Further, the processing device 1404 may be configured for identifying at least one of the at least one cost reducing tool of a plurality of cost reducing tools and the at least one economical cloud computing platform of a plurality of economical cloud computing platforms corresponding to at least one cloud computing platform of the plurality of cloud computing platforms based on the comparing. Further, the processing device 1404 may be configured for generating the at least one validation prompt corresponding to the at least one cost reducing tool and the at least one economical cloud computing platform. Further, the processing device 1404 may be configured for generating the plurality of optimization instructions based on the at least one prompt response. Further, in some embodiments, the plurality of optimization instructions may include a plurality of computer-executable instructions for optimizing cloud storage associated with the client.

Further, the storage device 1406 may be configured for retrieving the plurality of economical cloud computing information associated with the plurality of economical cloud computing platforms and the plurality of cost-reducing tools. Further, the plurality of economical cloud computing platforms may include cost-effective cloud computing platforms usable by the client. Further, the plurality of cost-reducing tools may include a plurality of techniques and strategies for reducing costs associated with the plurality of cloud computing platforms used by the client.

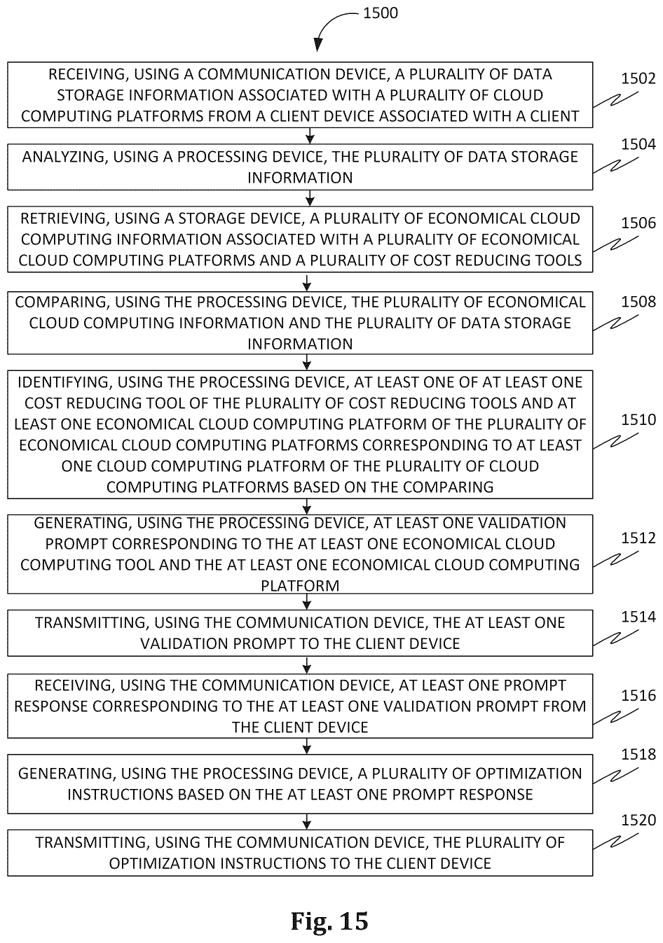

FIG. 15 is a flowchart of a method 1500 for facilitating cloud optimization, in accordance with some embodiments.

Further, the method 1500 may include a step 1502 of receiving, using a communication device, a plurality of data storage information associated with a plurality of cloud computing platforms from a client device associated with a client. Further, the plurality of data storage information may include, but may not be limited to, a plurality of payment statements associated with a plurality of services provided by the plurality of cloud computing platforms to the client, utilization information associated with the plurality of services, etc. Further, the plurality of cloud computing platforms may include, but may not be limited to, Azure™, AWS™, Google™, and so on.

Further, the method 1500 may include a step 1504 of analyzing, using a processing device, the plurality of data storage information.

Further, the method 1500 may include a step 1506 of retrieving, using a storage device, a plurality of economical cloud computing information associated with a plurality of economical cloud computing platforms and a plurality of cost-reducing tools. Further, the plurality of economical cloud computing platforms may include cost-effective cloud computing platforms usable by the client. Further, the plurality of cost-reducing tools may include a plurality of techniques and strategies for reducing costs associated with the plurality of cloud computing platforms used by the client.

Further, the method 1500 may include a step 1508 of comparing, using the processing device, the plurality of economical cloud computing information and the plurality of data storage information.

Further, the method 1500 may include a step 1510 of identifying, using the processing device, at least one of at least one cost-reducing tool of the plurality of cost-reducing tools and at least one economical cloud computing platform of the plurality of economical cloud computing platforms corresponding to at least one cloud computing platform of the plurality of cloud computing platforms based on the comparing.

Further, the method 1500 may include a step 1512 of generating, using the processing device, at least one validation prompt corresponding to the at least one cost-reducing tool and the at least one economical cloud computing platform.

Further, the method 1500 may include a step 1514 of transmitting, using the communication device, the at least one validation prompt to the client device.

Further, the method 1500 may include a step 1516 of receiving, using the communication device, at least one prompt response corresponding to the at least one validation prompt from the client device. Further, the at least one prompt response may include an acceptance of the at least one cost reducing tool and the at least one economical cloud computing platform by the client. Further, the at least one prompt response may include a rejection of the at least one cost reducing tool and the at least one economical cloud computing platform by the client.

Further, the method 1500 may include a step 1518 of generating, using the processing device, a plurality of optimization instructions based on the at least one prompt response. Further, in some embodiments, the plurality of optimization instructions may include a plurality of computer-executable instructions for optimizing cloud storage associated with the client.

Further, the method 1500 may include a step 1520 of transmitting, using the communication device, the plurality of optimization instructions to the client device.

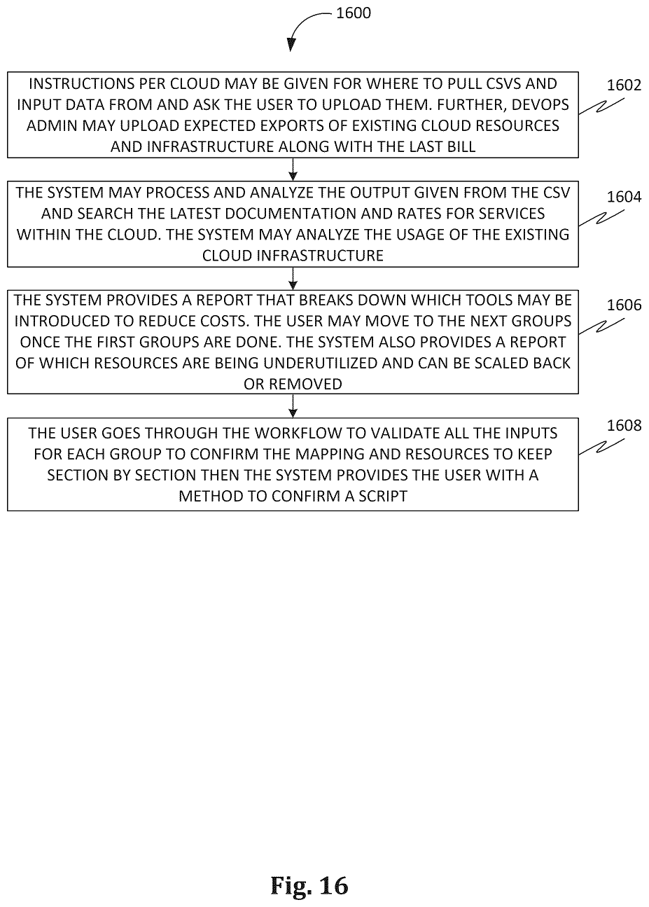

FIG. 16 is a flowchart of a method 1600 for facilitating cloud optimization and merging, in accordance with some embodiments.

Further, at 1602 of the method 1600, instructions per cloud may be given for where to pull CSVs and input data from and ask the user to upload them. Further, the DevOps admin may upload expected exports of existing cloud resources and infrastructure along with the last bill. Further, in some embodiments, the pulling of CSVs may include automated pulling through Cloud APIs using multi-cloud tools.

Further, at 1604 of the method 1600, the system may process and analyze the output given from the CSV and search the latest documentation and rates for services within the cloud. The system may analyze the usage of the existing cloud infrastructure.

Further, at 1606 of the method 1600, the system provides a report that breaks down which tools may be introduced to reduce costs. The user may move to the next groups once the first groups are done. The system also provides a report of which resources are being underutilized and may be scaled back or removed.

Further, at 1608 of the method 1600, the user goes through the workflow to validate all the inputs for each group to confirm the mapping and resources to keep section by section then the system provides the user with a method to confirm a script.

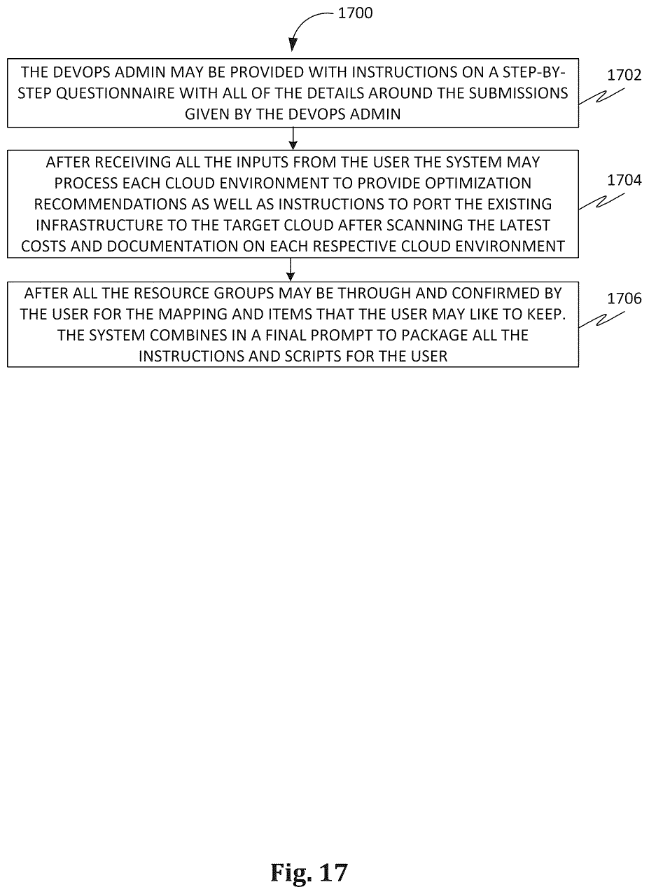

FIG. 17 is a flowchart of a method 1700 for facilitating cloud optimization and merging, in accordance with some embodiments.

Further, at 1702 of the method 1700, the DevOps admin may be provided with instructions on a step-by-step questionnaire with all of the details around the submissions given by the DevOps admin.

Further, at 1704 of the method 1700, after receiving all the inputs from the user the system may process each cloud environment to provide optimization recommendations as well as instructions to port the existing infrastructure to the target cloud after scanning the latest costs and documentation on each respective cloud environment.

Further, at 1706 of the method 1700, after all the resource groups may be through and confirmed by the user for the mapping and items that the user may like to keep. Further, the system combines in a final prompt to package all the instructions and scripts for the user.

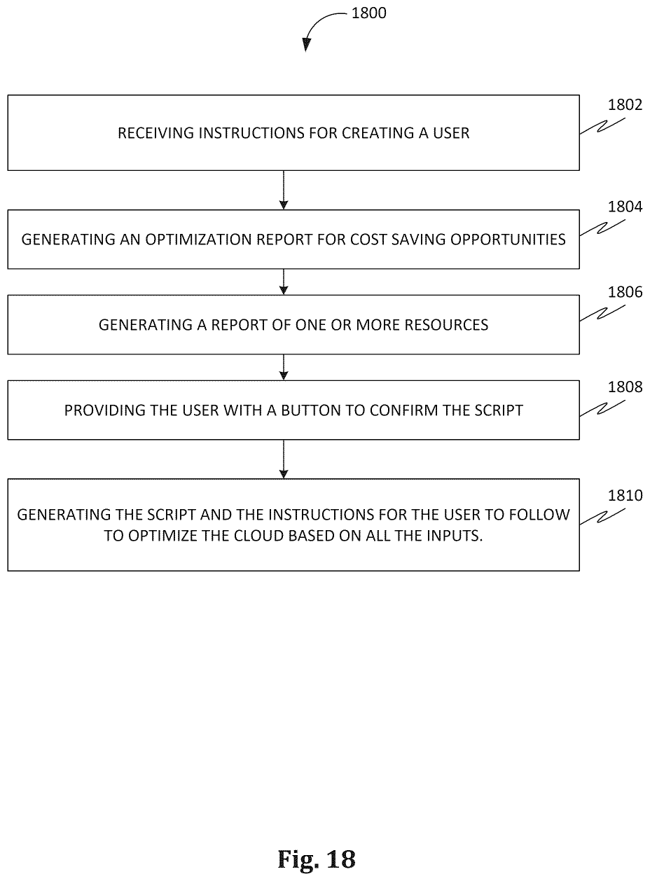

FIG. 18 is a flowchart of a method 1800 for facilitating cloud optimization, in accordance with some embodiments.

Further, at 1802, the method 1800 may include receiving instructions for creating a user that may read the cloud data for Azure™, AWS™, Google™ accounts. Further, the instructions may be received from the DevOps Admin. Further, the user may read the cloud data for Azure™, AWS™, and Google™ Accounts. Further, once permission is received based on a service account, the cloud may be scanned to pull all the usage data and information required to create an optimization report.

Further, at 1804 the method 1800 may include generating an optimization report for cost-saving opportunities. Further, the report may be downloaded from the OptiCloud web portal.

Further, at 1806, the method 1800 may include generating a report of one or more resources. Further, the one or more resources may be underutilized and may be scaled back or removed.

Further, at 1808, the method 1800 may include providing the user with a button to confirm the script. The button may be provided after the user goes through the workflow to validate all the inputs for each group to confirm the mapping and resources and the user wants to keep section by section. Further, the user's script may be generated. Further, the users may pay a fee for the service.

Further, at 1810, the method 1800 may include generating the script and the instructions for the user to follow to optimize the cloud based on all the inputs. Further, the generating of the script and the instructions may be performed after the user pays the fee for the service. Further, reports and notifications may be auto-generated to help companies manage the costs.

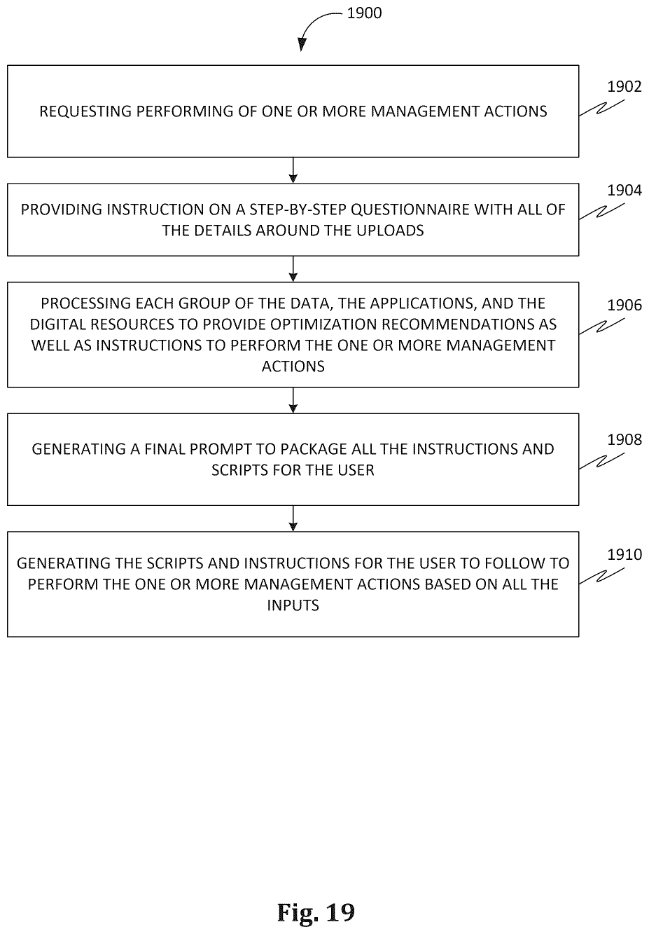

FIG. 19 is a flowchart of a method 1900 for facilitating cloud optimization, in accordance with some embodiments.

Further, at 1902, the method 1900 may include requesting performing of one or more management actions. Further, the one or more management actions may include merging data, applications, and digital resources from two or more cloud environments into one cloud environment, merging data, applications, and digital resources from two or more datacenters into one datacenter, migrating data, applications, and digital resources from one cloud environment to another cloud environment, migrating data, applications, and digital resources from one data center to another datacenter, migrating data, applications, and digital resources from a data center to a cloud environment, etc. Further, the merging and/or merging may be based on a payment of a subscription. Further, the DevOps admin may log into the system after paying for the subscription. Further, the system may tear down and decommission the clouds that should no longer persist.

Further, at 1904, the method 1900 may include providing instruction on a step-by-step questionnaire with all of the details around the uploads. Further, the instruction may be provided to the DevOps admin. Further, the DevOps Admin may need to provide uploads and background of each cloud environment (Azure™, AWS™, Google™), datacenters, etc.

Further, at 1906, the method 1900 may include processing each group of the data, the applications, and the digital resources to provide optimization recommendations as well as instructions to perform the one or more management actions. Further, the processing may be performed after receiving all the inputs from the user. Further, the processing may be performed after scanning the latest costs and documentation on each respective cloud environment and respective datacenter.

Further, at 1908, the method 1900 may include generating a final prompt to package all the instructions and scripts for the user. Further, the generating may be performed after all groups of the data, the applications, and the digital resources may be gone through and confirmed by the user for the mapping. Further, the generating may be performed by the confirmation of the items that the user would like to keep.

Further, at 1910, the method 1900 may include generating the scripts and instructions for the user to follow to perform the one or more management actions based on all the inputs. Further, the generating may be performed after the user pays a fee for the service. Further, there may also be a script generated to tear down the old cloud environment.

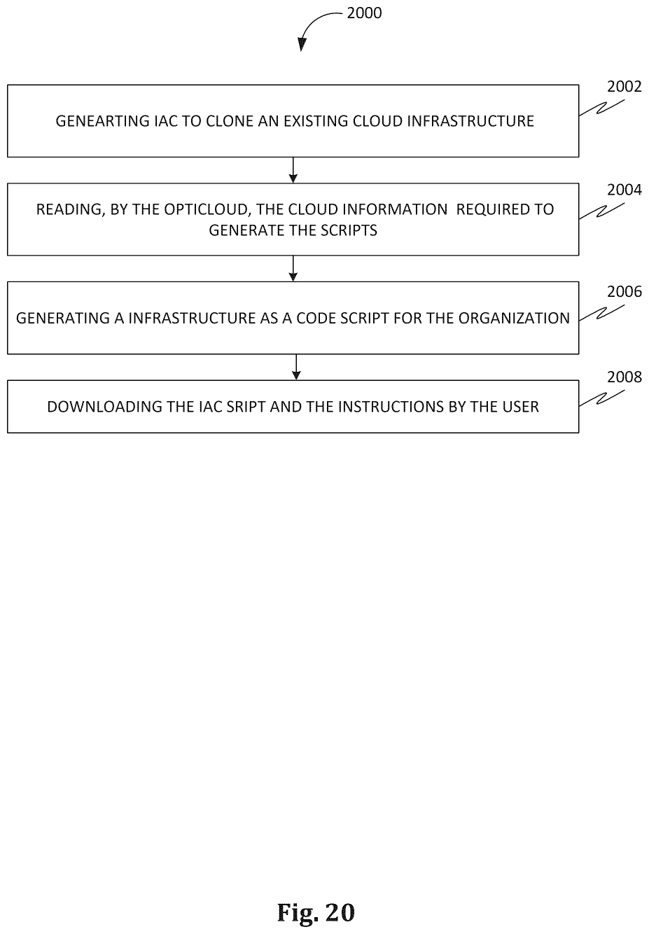

FIG. 20 is a flowchart of a method 2000 for facilitating cloud optimization, in accordance with some embodiments.

Further, at 2002, the method 2000 may include generating IAC to clone an existing cloud infrastructure. Further, the IAC may be for the DevOps Admin. Further, the generating of IAC may be performed after the DevOps Admin may log into the system after paying for a subscription. Further, the IAC may be cloned for speeding up development or for disaster recovery.

Further, at 2004, the method 2000 may include reading, by the OptiCloud, the cloud information required to generate the scripts. Further, the reading may be performed after setting up a user that may read the cloud environment (Azure™, AWS™, Google™).

Further, at 2006, the method 2000 may include generating an infrastructure as code script for the organization. Further, the generating may be performed after processing all the cloud data. Further, the system may store the infrastructure as a code script specifically for the customer's cloud infrastructure.

Further, at 2008, the method 2000 may include downloading the IAC script and the instructions by the user. Further, the downloading may be performed based on a payment of the service by the user.

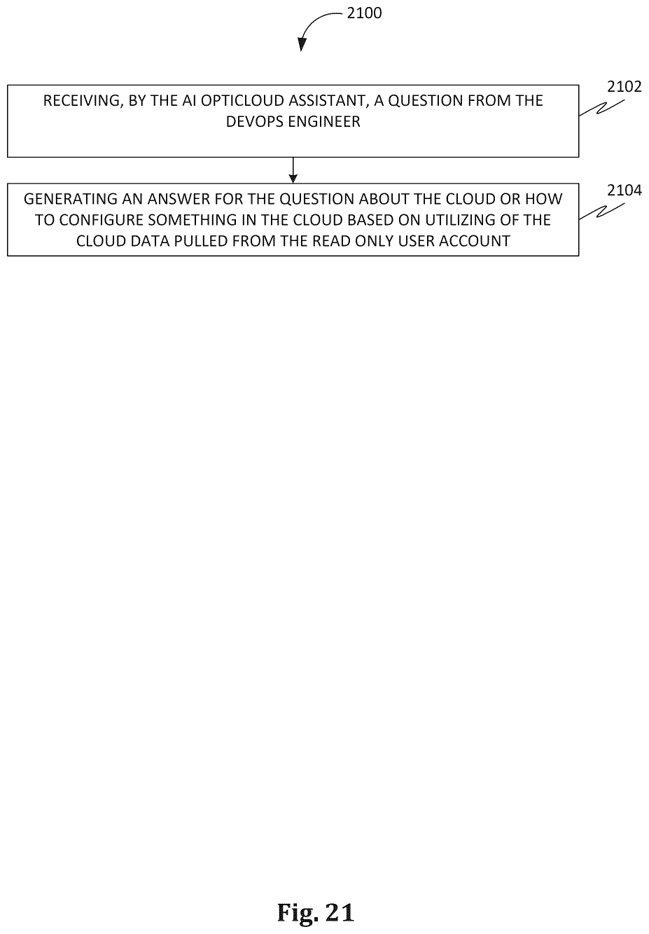

FIG. 21 is a flowchart of a method 2100 for facilitating cloud optimization, in accordance with some embodiments.

Further, at 2102, the method 2100 may include receiving, by the AI OptiCloud assistant, the question from the DevOps engineer.

Further, at 2104, the method 2100 may include generating an answer for a question about the cloud or how to configure something in the cloud based on utilizing the cloud data pulled from the read-only user account. Further, the utilizing may be performed by the AI assistant. Further, the AI assistant may utilize the information from the web scraper or other vector database attached to the AI assistant. Further, the generating of the answer may be based on the receiving of the question.

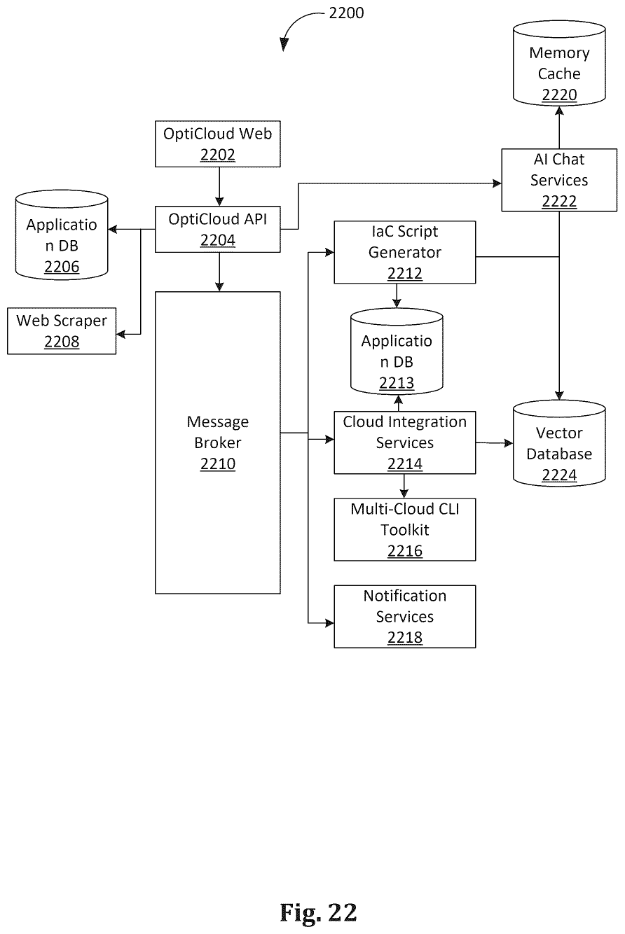

FIG. 22 is a block diagram of a system 2200 for facilitating cloud optimization, in accordance with some embodiments.

Further, the system 2200 may include an OptiCloud Web 2202, an OptiCloud API 2204, a first application DB 2206, a web scraper 2208, a message broker 2210, an IaC script generator 2212, a second application DB 2213, cloud Integration Services 2214, a multi-cloud CLI toolkit 2216, notification services 2218, a memory cache 2220, AI chat Services 2222 and a vector database 2224.

Further, the OptiCloud web 2202 may be connected to the Opticloud API 2204. Further, the Opticloud API 2204 may be connected to the first application DB 2206, the web scraper 2208, the message broker 2210, and the AI chat services 2222. Further, the message broker 2210 may be connected to the IaC script generator 2212, the cloud integration services 2214, and the notification services 2218. Further, the IaC script generator 2212 may be connected to the second application DB 2213 and the vector database 2224. Further, the cloud integration services 2214 may be connected to the second application DB 2213, the multi-cloud CLI toolkit 2216, and the vector database 2224. Further, the AI chat services may be connected to the memory cache 2220.

Further, the AI chat services 2222 may include generating an answer based on the receiving of a question by the user. Further, the AI chat services 2222 may include utilizing information pulled from the vector database 2224 and the Web Scraper 2208.

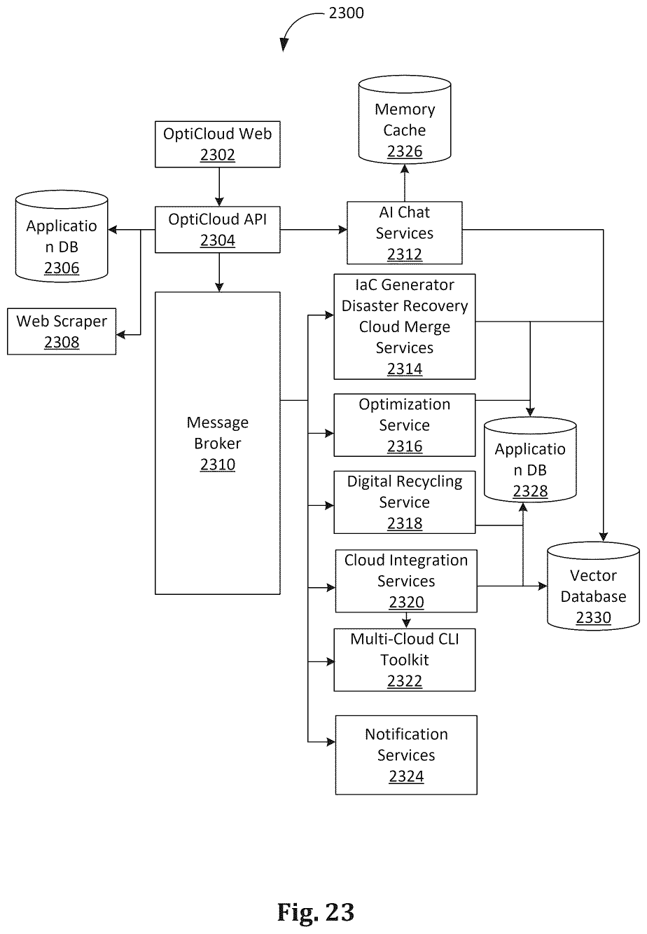

FIG. 23 is a block diagram of a system 2300 for facilitating cloud optimization, in accordance with some embodiments.

Further, the system 2300 may include an OptiCloud web 2302, an OptiCloud API 2304, a first application DB 2306, a web scraper 2308, a message broker 2310, AI chat services 2312, IaC generator disaster recovery cloud merge services 2314, an optimization service 2316, a digital recycling service 2318, cloud integration services 2320, a multi-cloud CLI toolkit 2322, notification services 2324, a memory cache 2326, a second application DB 2328, and a vector database 2330.

Further, the OptiCloud web 2302 may be connected to the Opticloud API 2304. Further, the Opticloud API 2304 may be connected to the first application DB 2306, the web scraper 2308, the message broker 2310, and the AI chat services 2312. Further, the message broker 2310 may be connected to the IaC generator disaster recovery cloud merge services 2314, the optimization service 2316, the digital recycling service 2318, the cloud integration services 2320, the multi-cloud CLI toolkit 2322, and the notification services 2324. Further, the AI chat services 2312 may be connected to the memory cache 2326. Further, the IaC generator disaster recovery cloud merge services 2314 may be connected to the second application DB 2328 and the vector database 2330. Further, the optimization service 2316 may be connected to the second application DB 2328. Further, the digital recycling service 2318 may be connected to the second application DB 2328. Further, the cloud integration services 2320 may be connected to the second application DB 2328 and the vector database 2330. Further, the cloud integration services 2320 may be connected to the multi-cloud CLI toolkit 2322.

Further, the Digital Recycling Service 2318 may include enabling the system 2300 for converting an optimized cloud infrastructure into carbon credits through a calculation of reduced carbon emissions that is created from the optimization of the cloud infrastructure. Further, the Optimization service 2316 may be associated with optimizing a cloud environment. Further, the AI chat services 2312 may include generating an answer based on the receiving of a question by the user. Further, the AI chat services 2312 may include utilizing information pulled from the vector database 2330 and the Web Scraper 2308.

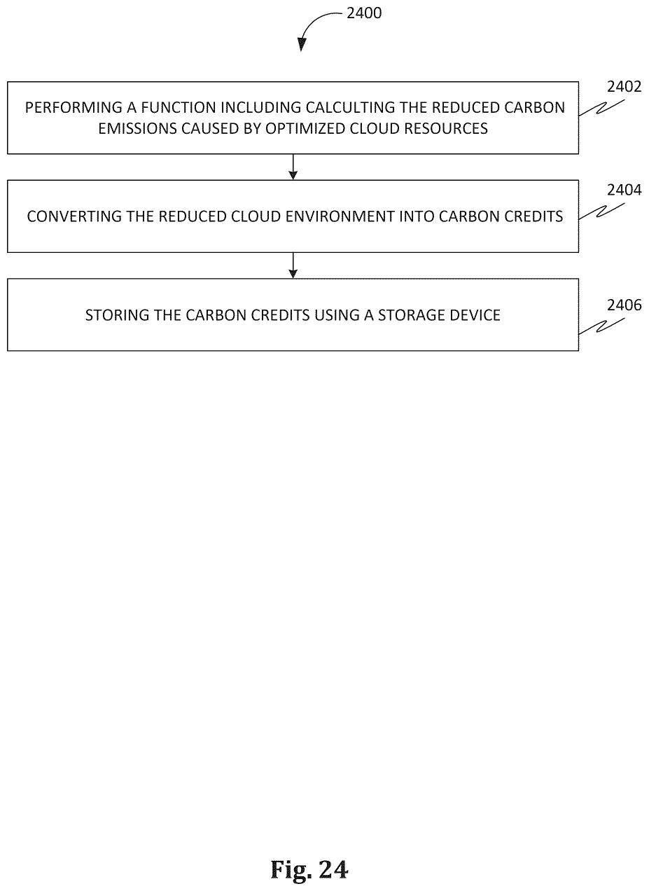

FIG. 24 is a flowchart of a method 2400 for facilitating cloud optimization, in accordance with some embodiments.

Further, at, 2402, the method 2400 may include performing a function including calculating the reduced carbon emissions caused by optimized cloud resources. Further, the reduced carbon emissions may be caused by a reduction in servers, compute, or storage of any digital assets into carbon credits.

Further, at 2404, the method 2400 may include converting the reduced cloud environment into carbon credits. Further, the converting may enable digital recycling.

Further, at 2406, the method 2400 may include storing the carbon credits using a storage device. Further, the carbon credits may be sold to carbon traders or companies that are in need.

Although the invention has been explained in relation to its preferred embodiment, it is to be understood that many other possible modifications and variations can be made without departing from the spirit and scope of the invention as hereinafter claimed.

What is claimed is:

1. A method for facilitating managing clouds for a user, the method comprising:
receiving, using a communication device, at least one request from at least one user device associated with the user;
receiving, using the communication device, at least one information from at least one device based on the at least one request, wherein the at least one information is associated with at least one cloud of the user, wherein the at least one cloud is provided to the user by at least one cloud platform;
analyzing, using a processing device, the at least one information;
determining, using the processing device, at least one cloud management action for managing the at least one cloud of the user based on the analyzing of the at least one information;
generating, using the processing device, at least one management information based on the determining of the at least one cloud management action, wherein the at least one management information facilitates a performing of the at least one cloud management action for the managing of the at least one cloud; and
transmitting, using the communication device, the at least one management information.

2. The method of claim 1 further comprising:
determining, using the processing device, a spending corresponding to a usage associated with the at least one cloud provided by the at least one cloud platform based on the analyzing of the at least one information;
obtaining, using the processing device, at least one first information based on the at least one request, wherein the at least one first information is associated with a plurality of cloud platforms; and
analyzing, using the processing device, the at least one first information and the spending corresponding to the usage using at least one machine learning model, wherein the at least one machine learning model determines a potential spending corresponding to the usage associated with the at least one cloud provided by each of the plurality of cloud platforms and compares the potential spending with the spending corresponding to the usage, wherein the determining of the at least one management action is further based on the analyzing of the at least one first information and the spending corresponding to the usage.

3. The method of claim 1 further comprising:
determining, using the processing device, at least one cloud metric of at least one cloud server associated with the at least one cloud based on the analyzing of the at least one information; and
generating, using the processing device, at least one recommendation for optimizing a spending associated with the at least one cloud based on the at least one cloud metric, wherein the generating of the at least one management information is further based on the at least one recommendation.

4. The method of claim 1 further comprising:
determining, using the processing device, at least one current cloud infrastructure information of a current cloud infrastructure associated with the at least one cloud based on the analyzing of the at least one information;
analyzing, using the processing device, the at least one current cloud infrastructure information;
determining, using the processing device, a digital waste associated with the at least one cloud based on the analyzing of the at least one current cloud infrastructure information; and
determining, using the processing device, at least one optimized cloud infrastructure information of an optimized cloud infrastructure associated with the at least one cloud based on the at least one current cloud infrastructure information, the digital waste, and the at least one cloud management action, wherein the generating of the at least one management information is further based on the at least one optimized cloud infrastructure.

5. The method of claim 4 further comprising:
determining, using the processing device, at least one of an energy consumption and a carbon emission associated with the current cloud infrastructure based on the analyzing of the at least one current cloud infrastructure information;
calculating, using the processing device, a reduction in at least one of the energy consumption and the carbon emission based on at least one of the energy consumption and the carbon emission associated with the current cloud infrastructure, and the at least one optimized cloud infrastructure information;
converting, using the processing device, the reduction in at least one of the energy consumption and the carbon emission into a carbon credit using at least one standard based on the calculating of the reduction in at least one of the energy consumption and the carbon emission;
generating, using the processing device, at least one carbon credit information based on the converting of the reduction in at least one of the energy consumption and the carbon emission into the carbon credit; and
transmitting, using the communication device, the at least one carbon credit information.

6. The method of claim 1 further comprising creating, using the processing device, at least one artificial intelligent autonomous agent based on the determining of the at least one cloud management action, wherein the at least one artificial intelligent autonomous agent is configured for autonomously handling at least one task associated with the at least one cloud management action based on the at least one management information.

7. The method of claim 1, wherein the at least one cloud is synchronized with at least one external device, wherein the method further comprises determining, using the processing device, at least one device management action for the at least one external device based on the determining of the at least one cloud management action, wherein the generating of the at least one management information is further based on the determining of the at least one device management action, wherein the at least one management information facilitates a performing of the at least one device management action for the managing of the at least one external device.

8. The method of claim 7 further comprising:
obtaining, using the processing device, at least one device data associated with the at least one external device;
analyzing, using the processing device, the at least one device data;
determining, using the processing device, a digital waste associated with the at least one external device based on the analyzing of the at least one device data, wherein the determining of the at least one device management action is further based on the digital waste associated with the at least one external device;
calculating, using the processing device, a reduction in an energy consumption of the at least one external device based on the at least one device data, the digital waste, and the at least one device management action;
converting, using the processing device, the reduction in the energy consumption into a carbon credit using at least one standard based on the calculating of the reduction in the carbon emission;
generating, using the processing device, at least one carbon credit information based on the converting of the reduction in the energy consumption into the carbon credit; and
transmitting, using the communication device, the at least one carbon credit information.

9. The method of claim 1 further comprising:
generating, using the processing device, at least one initial management information based on the determining of the at least one cloud management action, wherein the at least one initial management information comprises at least one report associated with the at least one cloud, wherein the at least one report comprises at least one of at least one optimization tool required for optimizing the at least one cloud, and at least one usage parameter associated with at least one cloud resource associated with the at least one cloud;
transmitting, using the communication device, the at least one initial management information to the at least one user device; and
receiving, using the communication device, at least one response of the at least one user associated with at least one of the at least one optimization tool and the at least one cloud resource from the at least one user device, wherein the generating of the at least one management information is further based on the at least one initial management information and the at least one response.

10. The method of claim 1 further comprising:
generating, using the processing device, at least one questionnaire and at least one instruction associated with the at least one questionnaire for the user based on the analyzing of the at least one information, and the at least one request;
transmitting, using the communication device, the at least one questionnaire and the at least one instruction to the at least one user device; and
receiving, using the communication device, at least one input of the user associated with the at least one questionnaire from the at least one user device, wherein the analyzing of the at least one information comprises analyzing the at least one information based on the at least one input, the at least one questionnaire, and the at least one instruction.

11. A system for facilitating managing clouds for a user, the system comprising:
a communication device configured for:
receiving at least one request from at least one user device associated with the user;
receiving at least one information from at least one device based on the at least one request, wherein the at least one information is associated with at least one cloud of the user, wherein the at least one cloud is provided to the user by at least one cloud platform; and
transmitting at least one management information;
a processing device communicatively coupled with the communication device, wherein the processing device is configured for:
analyzing the at least one information;
determining at least one cloud management action for managing the at least one cloud of the user based on the analyzing of the at least one information; and
generating the at least one management information based on the determining of the at least one cloud management action, wherein the at least one management information facilitates a performing of the at least one cloud management action for the managing of the at least one cloud.

12. The system of claim 11, wherein the processing device is further configured for:
determining a spending corresponding to a usage associated with the at least one cloud provided by the at least one cloud platform based on the analyzing of the at least one information;
obtaining at least one first information based on the at least one request, wherein the at least one first information is associated with a plurality of cloud platforms; and
analyzing the at least one first information and the spending corresponding to the usage using at least one machine learning model, wherein the at least one machine learning model determines a potential spending corresponding to the usage associated with the at least one cloud provided by each of the plurality of cloud platforms and compares the potential spending with the spending corresponding to the usage, wherein the determining of the at least one management action is further based on the analyzing of the at least one first information and the spending corresponding to the usage.

13. The system of claim 11, wherein the processing device is further configured for:
determining at least one cloud metric of at least one cloud server associated with the at least one cloud based on the analyzing of the at least one information; and
generating at least one recommendation for optimizing a spending associated with the at least one cloud based on the at least one cloud metric, wherein the generating of the at least one management information is further based on the at least one recommendation.

14. The system of claim 11, wherein the processing device is further configured for:
determining at least one current cloud infrastructure information of a current cloud infrastructure associated with the at least one cloud based on the analyzing of the at least one information;
analyzing the at least one current cloud infrastructure information;
determining a digital waste associated with the at least one cloud based on the analyzing of the at least one current cloud infrastructure information; and
determining at least one optimized cloud infrastructure information of an optimized cloud infrastructure associated with the at least one cloud based on the at least one current cloud infrastructure information, the digital waste, and the at least one cloud management action, wherein the generating of the at least one management information is further based on the at least one optimized cloud infrastructure.

15. The system of claim 14, wherein the processing device is further configured for:
determining at least one of an energy consumption and a carbon emission associated with the current cloud infrastructure based on the analyzing of the at least one current cloud information;
calculating a reduction in at least one of the energy consumption and the carbon emission based on at least one of the energy consumption and the carbon emission associated with the current cloud infrastructure, and the at least one optimized cloud infrastructure information;
converting the reduction in at least one of the energy consumption and the carbon emission into a carbon credit using at least one standard based on the calculating of the reduction in at least one of the energy consumption and the carbon emission; and
generating at least one carbon credit information based on the converting of the reduction in at least one of the energy consumption and the carbon emission into the carbon credit, wherein the communication device is further configured for transmitting the at least one carbon credit information.

16. The system of claim 11, wherein the processing device is further configured for creating at least one artificial intelligent autonomous agent based on the determining of the at least one cloud management action, wherein the at least one artificial intelligent autonomous agent is configured for autonomously handling at least one task associated with the at least one cloud management action based on the at least one management information.

17. The system of claim 11, wherein the at least one cloud is synchronized with at least one external device, wherein the processing device is further configured for determining at least one device management action for the at least one external device based on the determining of the at least one cloud management action, wherein the generating of the at least one management information is further based on the determining of the at least one device management action, wherein the at least one management information facilitates a performing of the at least one device management action for the managing of the at least one external device.

18. The system of claim 17, wherein the processing device is further configured for:
obtaining at least one device data associated with the at least one external device;
analyzing the at least one device data;
determining a digital waste associated with the at least one external device based on the analyzing of the at least one device data, wherein the determining of the at least one device management action is further based on the digital waste associated with the at least one external device;
calculating a reduction in an energy consumption of the at least one external device based on the at least one device data, the digital waste, and the at least one device management action;
converting the reduction in the energy consumption into a carbon credit using at least one standard based on the calculating of the reduction in the carbon emission; and
generating at least one carbon credit information based on the converting of the reduction in the energy consumption into the carbon credit, wherein the communication device is further configured for transmitting the at least one carbon credit information.

19. The system of claim 11, wherein the processing device is further configured for generating at least one initial management information based on the determining of the at least one cloud management action, wherein the at least one initial management information comprises at least one report associated with the at least one cloud, wherein the at least one report comprises at least one of at least one optimization tool required for optimizing the at least one cloud, and at least one usage parameter associated with at least one cloud resource associated with the at least one cloud, wherein the communication device is further configured for:
transmitting the at least one initial management information to the at least one user device; and
receiving at least one response of the at least one user associated with at least one of the at least one optimization tool and the at least one cloud resource from the at least one user device, wherein the generating of the at least one management information is further based on the at least one initial management information and the at least one response.

20. The system of claim 11, wherein the processing device is further configured for generating at least one questionnaire and at least one instruction associated with the at least one questionnaire for the user based on the analyzing of the at least one information, and the at least one request, wherein the communication device is further configured for:
transmitting the at least one questionnaire and the at least one instruction to the at least one user device; and
receiving at least one input of the user associated with the at least one questionnaire from the at least one user device, wherein the analyzing of the at least one information comprises analyzing the at least one information based on the at least one input, the at least one questionnaire, and the at least one instruction.
